(19) United States
(12) Patent Application Publication
(10) Pub. No.: US 2024/0154743 A1
(43) Pub. Date: May 9, 2024

(54) WIRELESS COMMUNICATION DEVICE CONTROLLED OPERATION MODE

(71) Applicant: QUALCOMM Incorporated, San Diego, CA (US)

(72) Inventors: Navid ABEDINI, Basking Ridge, NJ (US); Tao LUO, San Diego, CA (US)

(21) Appl. No.: 18/494,461

(22) Filed: Oct. 25, 2023

Related U.S. Application Data
(60) Provisional application No. 63/382,430, filed on Nov. 4, 2022.

(51) Int. Cl. H04L 5/00

(52) U.S. Cl. CPC H04L 5/0023; H04L 5/0055

(57) ABSTRACT

Various aspects of the present disclosure generally relate to wireless communication. In some aspects, a forwarding node may transmit an indication of a selection of a wireless communication device (WCD) controlled operation mode, wherein the selection is obtained from a control node or determined by the forwarding node. The forwarding node may communicate with a WCD based at least in part on the WCD-controlled operation mode. Numerous other aspects are described.

### CROSS-REFERENCE TO RELATED APPLICATION

This patent application claims priority to U.S. Provisional Patent Application No. 63/382,430, filed on Nov. 4, 2022, entitled “WIRELESS COMMUNICATION DEVICE CONTROLLED OPERATION MODE,” and assigned to the assignee hereof. The disclosure of the prior application is considered part of and is incorporated by reference into this patent application.

### INTRODUCTION

Aspects of the present disclosure generally relate to wireless communication and to techniques and apparatuses for communicating using a forwarding node.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a forwarding node. The method may include transmitting an indication of a selection of a wireless communication device (WCD) controlled operation mode. The method may include communicating with a WCD based at least in part on the WCD-controlled operation mode.

Some aspects described herein relate to a method of wireless communication performed at a WCD. The method may include receiving an indication of a selection of a WCD-controlled operation mode associated with a forwarding node. The method may include communicating, via the forwarding node, with an additional WCD based at least in part on the WCD-controlled operation mode.

Some aspects described herein relate to a forwarding node for wireless communication. The forwarding node may include a memory and one or more processors coupled to the memory. The one or more processors may be configured to transmit an indication of a selection of a WCD-controlled operation mode. The one or more processors may be configured to communicate with a WCD based at least in part on the WCD-controlled operation mode.

Some aspects described herein relate to a WCD for wireless communication. The wireless communication device may include a memory and one or more processors coupled to the memory. The one or more processors may be configured to receive an indication of a selection of a WCD-controlled operation mode associated with a forwarding node. The one or more processors may be configured to communicate, via the forwarding node, with an additional WCD based at least in part on the WCD-controlled operation mode.

Some aspects described herein relate to an apparatus for wireless communication at a node. The apparatus may include one or more memories. The apparatus may include one or more processors coupled with the one or more memories. The one or more processors may be configured to cause the node to transmit an indication of a selection of a WCD-controlled operation mode. The one or more processors may be configured to cause the node to communicate with a WCD based at least in part on the WCD-controlled operation mode.

Some aspects described herein relate to an apparatus for wireless communication at a WCD. The apparatus may include one or more memories. The apparatus may include one or more processors coupled with the one or more memories. The one or more processors may be configured to cause the WCD to receive an indication of a selection of a WCD-controlled operation mode associated with a forwarding node. The apparatus may include one or more processors coupled with the one or more memories. The one or more processors may be configured to cause the WCD to communicate, via the forwarding node, with an additional WCD based at least in part on the WCD-controlled operation mode.

Some aspects described herein relate to a non-transitory computer-readable medium that stores a set of instructions for wireless communication by a forwarding node. The set of instructions, when executed by one or more processors of the forwarding node, may cause the forwarding node to transmit an indication of a selection of a WCD-controlled operation mode. The set of instructions, when executed by one or more processors of the forwarding node, may cause the forwarding node to communicate with a WCD based at least in part on the WCD-controlled operation mode.

Some aspects described herein relate to a non-transitory computer-readable medium that stores a set of instructions for wireless communication by a WCD. The set of instructions, when executed by one or more processors of the WCD, may cause the WCD to receive an indication of a selection of a WCD-controlled operation mode associated with a forwarding node. The set of instructions, when executed by one or more processors of the WCD, may cause the WCD to communicate, via the forwarding node, with an additional WCD based at least in part on the WCD-controlled operation mode.

Some aspects described herein relate to an apparatus for wireless communication. The apparatus may include means for transmitting an indication of a selection of a WCD-controlled operation mode. The apparatus may include means for communicating with a WCD based at least in part on the WCD-controlled operation mode.

Some aspects described herein relate to an apparatus for wireless communication. The apparatus may include means for receiving an indication of a selection of a WCD-controlled operation mode associated with a forwarding node. The apparatus may include means for communicating, via the forwarding node, with an additional WCD based at least in part on the WCD-controlled operation mode.

Some aspects described herein relate to a method of wireless communication performed at a forwarding node. The method may include transmitting an indication of a selection of a wireless communication device (WCD) controlled operation mode, wherein the selection is obtained from a control node or determined by the forwarding node. The method may include communicating with a WCD based at least in part on the WCD-controlled operation mode.

Some aspects described herein relate to an apparatus for wireless communication at a forwarding node. The apparatus may include one or more memories. The apparatus may include one or more processors coupled with the one or more memories. The one or more processors may be configured to cause the forwarding node to transmit an indication of a selection of a WCD-controlled operation mode, wherein the selection is obtained from a control node or determined by the forwarding node. The one or more processors may be configured to cause the forwarding node to communicate with a WCD based at least in part on the WCD-controlled operation mode.

Some aspects described herein relate to a non-transitory computer-readable medium that stores a set of instructions for wireless communication by a forwarding node. The set of instructions, when executed by one or more processors of the forwarding node, may cause the forwarding node to transmit an indication of a selection of a WCD-controlled operation mode, wherein the selection is obtained from a control node or determined by the forwarding node. The set of instructions, when executed by one or more processors of the forwarding node, may cause the forwarding node to communicate with a WCD based at least in part on the WCD-controlled operation mode.

Some aspects described herein relate to an apparatus for wireless communication. The apparatus may include means for transmitting an indication of a selection of a WCD-controlled operation mode, wherein the selection is obtained from a control node or determined by the forwarding node. The apparatus may include means for communicating with a WCD based at least in part on the WCD-controlled operation mode.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communicating using a millimeter wave repeater, in accordance with the present disclosure.

FIG. 5 is a diagram illustrating an example of communicating using a forwarding node, in accordance with the present disclosure.

FIG. 6 is a diagram of an example associated with communicating using a wireless communication device controlled operation mode for a forwarding node, in accordance with the present disclosure.

FIG. 7 is a diagram illustrating an example of communicating using a forwarding node, in accordance with the present disclosure.

FIG. 8 is a diagram illustrating an example process performed, for example, by a forwarding node, in accordance with the present disclosure.

FIG. 9 is a diagram illustrating an example process performed, for example, by a WCD, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

FIG. 12 is a diagram illustrating an example process performed, for example, by a forwarding node, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example implementation of code and circuitry for an apparatus, in accordance with the present disclosure.

FIG. 16 is a diagram illustrating an example of a hardware implementation for an apparatus employing a processing system, in accordance with the present disclosure.

FIG. 17 is a diagram illustrating an example implementation of code and circuitry for an apparatus, in accordance with the present disclosure.

### DETAILED DESCRIPTION

In some networks, forwarding nodes may be used to relay and/or repeat information between wireless communication devices. For example, some networks may operate in frequencies with increased propagation losses where a range of wireless transmissions is insufficient to establish direct communication links between wireless communication devices (WCDs). In this case, a forwarding node (e.g., a relay and/or a repeater) may receive communications from a first WCD and forward the communications to a second WCD. In this way, the first WCD and the second WCD may communicate via the forwarding node. The forwarding node may be an electronic device that receives a signal from the first WCD, amplifies the signal to create an amplified signal, and then sends the amplified signal to the second WCD.

The forwarding node may establish a control link with the first WCD (e.g., a network node and/or a user equipment (UE)) through which the forwarding node receives control information. For example, the forwarding node may include a network controlled repeater (NCR). An NCR may include a repeater and/or a relay that forwards communications based at least in part on controls provided by a network operator or a network node. In some examples, the first WCD may be associated with the network provider (e.g., as a network node, a central unit, a distributed unit, or another network entity) that is configured to provide control information to the NCR. The first WCD may indicate that the NCR is to support the network operator with communications between network nodes and WCDs (e.g., UEs or other devices that are not network controlled) or between multiple WCDs.

The control information indicates one or more parameters for forwarding, such as beamforming information for a link between the forwarding node and a second WCD that is in communication with the first WCD (e.g., an access link or a sidelink), time division duplexing (TDD), on-off controls, a power configuration, a frequency configuration for forwarding, and/or beamforming information for a link between the forwarding node and the first WCD (e.g., a backhaul link or a sidelink). However, when the first WCD provides the control information to the forwarding node, the first WCD consumes network resources and/or reduces a throughput of the forwarding node based at least in part on using resource for the control information that may have otherwise been used to carry data or other communications to be forwarded to a second WCD.

In some aspects described herein, a forwarding node may be configured to operate using a WCD-controlled operation mode that is associated with an amount of control information that the forwarding node can identify without receiving an indication from the first WCD. In some aspects, the forwarding node may select the WCD-controlled operation mode from a set of candidate WCD-controlled operation modes that are associated with different amounts of control information that the forwarding node can identify without receiving an indication from the first WCD. For example, a first candidate WCD-controlled operation mode may be associated with the forwarding node identifying a first information element of control information (e.g., beamforming information for a link between the forwarding node and the first WCD) and the first WCD providing remaining information elements of the control information. A second candidate WCD-controlled operation mode may be associated with the forwarding node identifying a second information element of control information (e.g., transmission power for forwarding a communication via the link between the forwarding node and the first WCD) and the first WCD providing remaining information elements of the control information. A third candidate WCD-controlled operation mode may be associated with the forwarding node identifying the first and the second information elements of control information and the first WCD providing remaining information elements of the control information.

For example, the forwarding node may select the WCD-controlled operation mode based at least in part on one or more parameters (e.g., values associated with the one or more parameters), such as channel conditions of a wireless link from the first WCD and the forwarding node, channel conditions of a wireless link from the forwarding node to the second WCD, mobility of the forwarding node, mobility of the first WCD, mobility of the second WCD in communication with the first WCD via the forwarding node, and/or a likelihood of success of autonomous identification of control information (e.g., identification of one or more elements of the control information without an indication of the one or more elements by the first WCD) by the forwarding node, among other examples.

The forwarding node may transmit an indication of the selection of the WCD-controlled operation mode to the first WCD. Based at least in part on the WCD-controlled operation mode, the first WCD may transmit a set of information elements of control information that is based at least in part on the WCD-controlled operation mode (e.g., information elements included in the set of information elements is based at least in part on the WCD-controlled operation mode). The first WCD and the second WCD may communication via the forwarding node based at least in part on the WCD-controlled operation mode (e.g., based at least in part on using one or more information elements of control information that are selected and/or identified by the forwarding node without an indication from the first WCD). In this way, the forwarding node may select, based at least in part on parameters at the forwarding node, an amount of control information that the first WCD is to transmit to the forwarding node for operation in forwarding communications from the first WCD to the second WCD. Based at least in part on the amount of control information transmitted to the forwarding node (e.g., associated with the WCD-controlled operation mode) being indicated by the forwarding node, the amount of control information and associated consumption of network resources may be reduced. Additionally, or alternatively, the amount of reduction being selected by the forwarding node may reduce communication errors that may have otherwise been caused by inaccurate selection by the first WCD (e.g., inaccurate based at least in part on not having access to information observed at the forwarding node).

In some aspects, the forwarding node may forward signals between any two WCDs, such as the first WCD and the second WCD. The second WCD may be, for example, a UE, a network node, another forwarding node (e.g., another repeater or another relay), or a radio unit (RU). A control node (e.g., a control entity) may be used to control the forwarding node. The control node may reside at the first WCD, the second WCD, or another WCD. The control node may reside at the forwarding node. The control node may reside in a third entity (e.g., a non-network node residing in a cloud environment). Different modes of control may relate to which entity is a control entity, which may depend on whether the control node resides at a WCD, the forwarding node, or the third entity residing in the cloud environment. Multiple modes of control may be supported, and switching between the multiple modes may be based at least in part on indications initiated and/or transmitted by the forwarding node.

In some aspects, by enabling an ability to switch between the multiple modes, a network may be given increased flexibility with respect to which entity controls the forwarding node. For example, a network may select a control node residing in a UE to control the forwarding node. As another example, the network may select a control node residing is another forwarding node to control the forwarding node. Such flexibility may allow certain entities to be selected to control the forwarding node, while other entities may not be selected to control the forwarding node, which may result in improved data rates when forwarding data, thereby improving an overall system performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

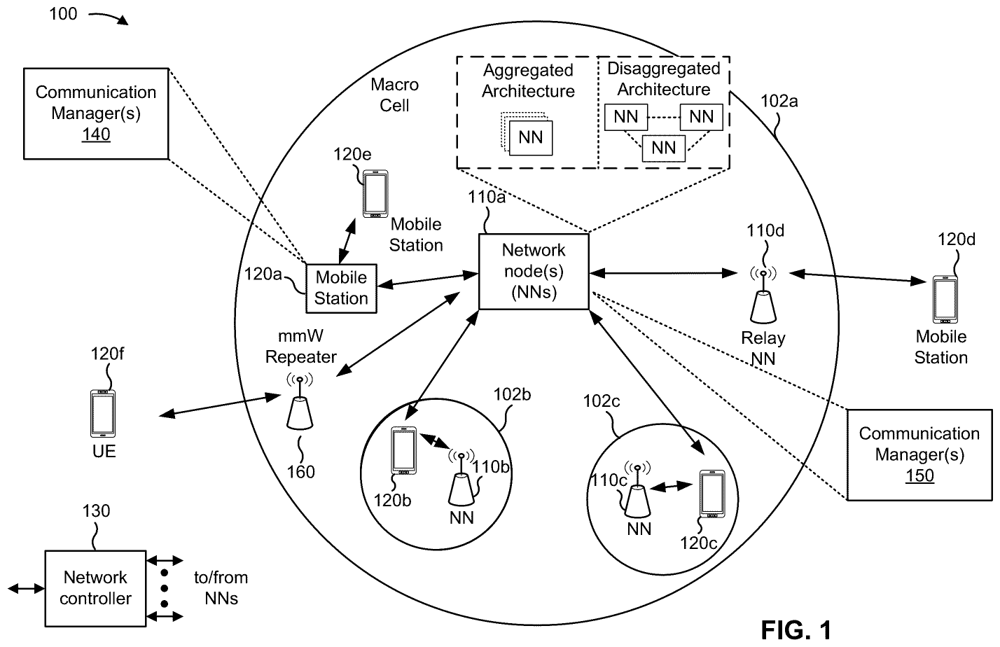

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more RUs).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed at the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the forwarding node may include a communication manager 140 or 150. As described in more detail elsewhere herein, the communication manager 140 or 150 may transmit an indication of a selection of a WCD-controlled operation mode, wherein the selection is obtained from a control node or determined by the forwarding node; and communicate with a WCD based at least in part on the WCD-controlled operation mode. Additionally, or alternatively, the communication manager 140 or 150 may perform one or more other operations described herein. The forwarding node may include a mobile terminal (MT) component that operates similar to a UE 120 and/or may include forwarding component that operates similar to a network node 110 (e.g., with a configured amount of processing on forwarded communications).

In some aspects, the WCD may include a communication manager 140 or 150. The WCD may include a network node 110 or a UE 120. As described in more detail elsewhere herein, the communication manager 140 or 150 may receive an indication of a selection of a WCD-controlled operation mode associated with a forwarding node; and communicate, via the forwarding node, with an additional WCD based at least in part on the WCD-controlled operation mode. Additionally, or alternatively, the communication manager 140 or 150 may perform one or more other operations described herein.

In some aspects, a millimeter wave (mmW) repeater 160 may receive a millimeter wave signal (e.g., an analog millimeter wave signal) from a network node 110, may amplify the millimeter wave signal, and may transmit the amplified millimeter wave signal to one or more UEs 120 (e.g., shown as UE 120f). In some aspects, the mmW repeater 160 may be an analog mmW repeater, sometimes also referred to as a layer 1 mmW repeater. Additionally, or alternatively, the mmW repeater 160 may be a wireless TRP acting as a distributed unit (e.g., of a 5G access node) that communicates wirelessly with a network node 110 acting as a central unit or an access node controller (e.g., of the 5G access node). The mmW repeater may receive, amplify, and transmit the analog mmW signal without performing analog-to-digital conversion of the analog mmW signal and/or without performing any digital signal processing on the mmW signal. In this way, latency may be reduced and a cost to produce the mmW repeater 160 may be reduced.

As indicated above, FIG. 1 is provided as an example. Other examples may differ from what is described with regard to FIG. 1.

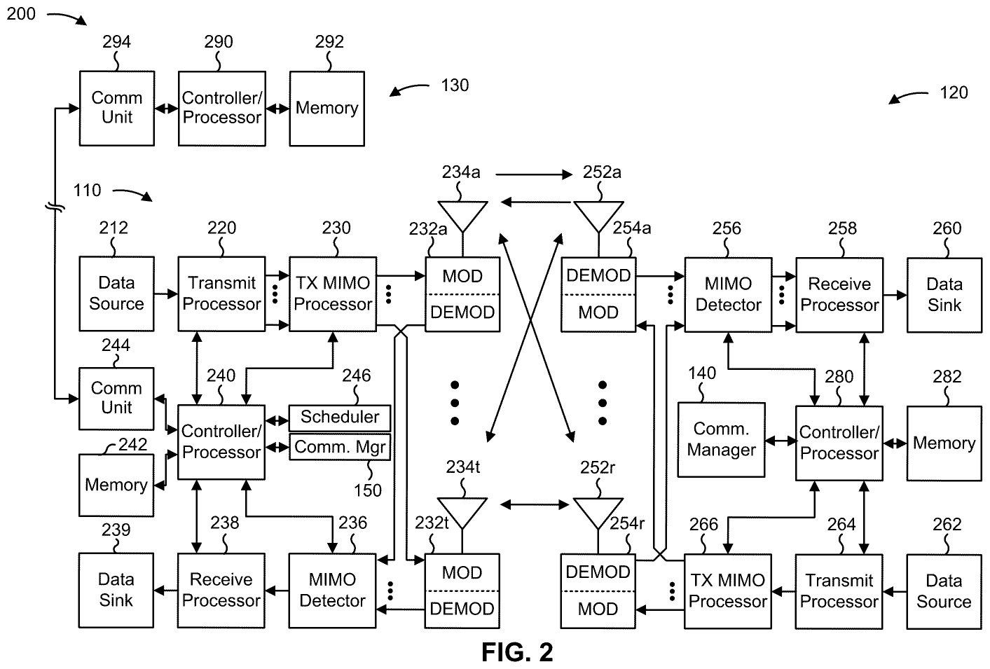

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T>1). The UE 120 may be equipped with a set of antennas 252a through 252r, such as R antennas (R>1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

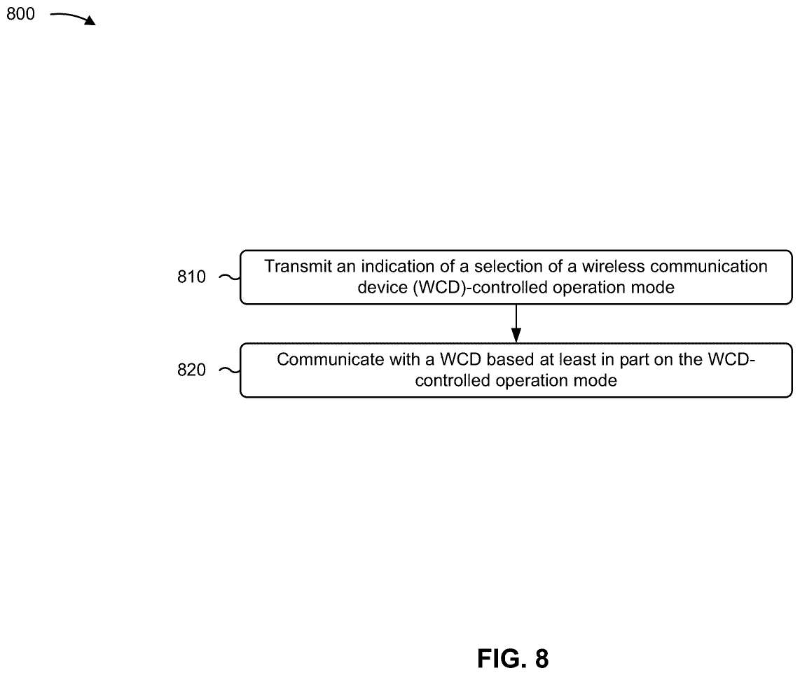

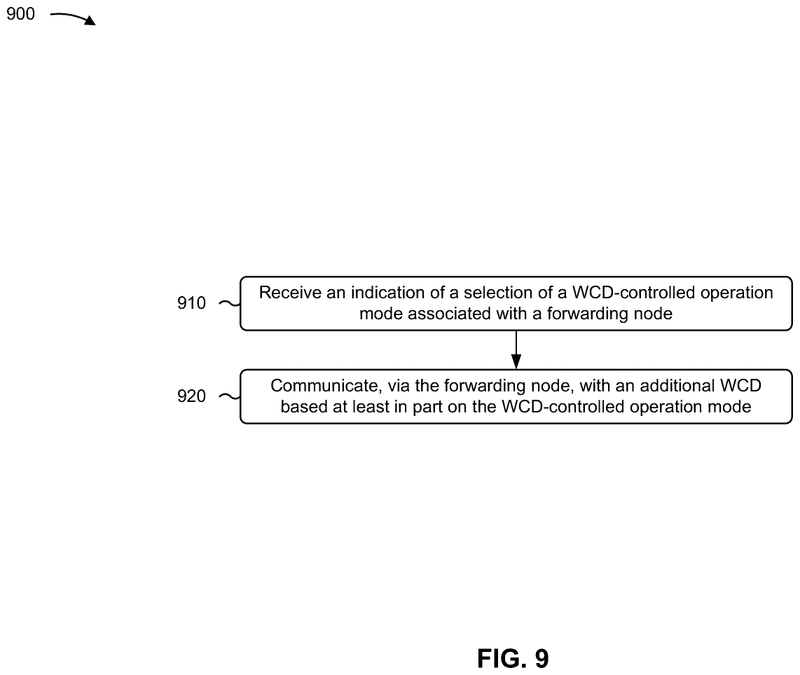

The controller/processor 240 of a forwarding node or WCD (e.g., a network node 110), the controller/processor 280 of a WCD (e.g., the UE 120), and/or any other component(s) of FIG. 2 may perform one or more techniques associated with communicating using a wireless communication device controlled operation mode for a forwarding node, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the forwarding node includes means for transmitting an indication of a selection of a WCD-controlled operation mode, wherein the selection is obtained from a control node or determined by the forwarding node; and/or means for communicating with a WCD based at least in part on the WCD-controlled operation mode. In some aspects, the means for the forwarding node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the forwarding node to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the WCD includes means for receiving an indication of a selection of a WCD-controlled operation mode associated with a forwarding node; and/or means for communicating, via the forwarding node, with an additional WCD based at least in part on the WCD-controlled operation mode. In some aspects, the means for the WCD to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the WCD to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

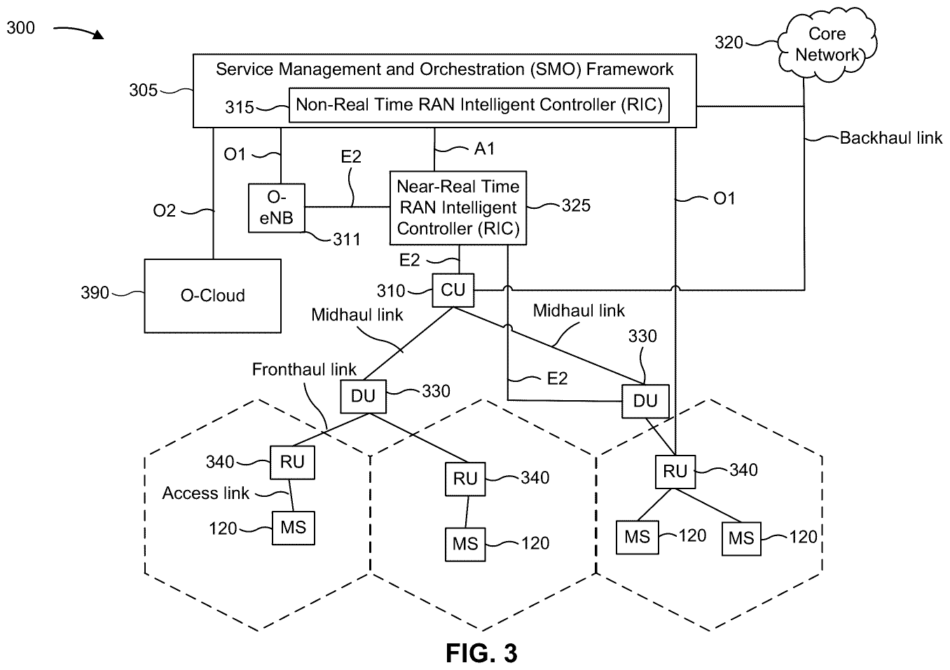

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

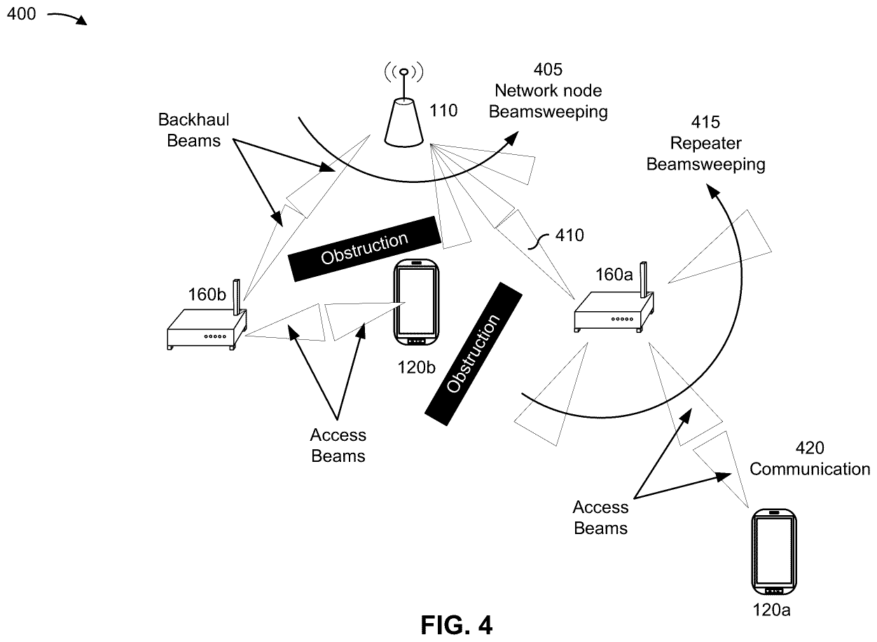

FIG. 4 is a diagram illustrating an example 400 of communicating using a millimeter wave repeater, in accordance with the present disclosure.

Because millimeter wave communications have a higher frequency and shorter wavelength than other types of radio waves used for communications (e.g., sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110. However, a millimeter wave may not be capable of penetrating the same wall (e.g., depending on a thickness of the wall and/or a material from which the wall is constructed). Some techniques and apparatuses described herein use a millimeter wave repeater 160 (which includes, in the example of FIG. 4, repeater 160a and repeater 160b) to increase the coverage area of a network node 110 and/or to extend coverage to UEs 120 (which include, in the example of FIG. 4, UE 120a and UE 120b) without line of sight to the network node 110 (e.g., due to an obstruction).

For example, as illustrated in the example of FIG. 4, an obstruction between UE 120b and network node 110 blocks or otherwise reduces the quality of a link between the network node 110 and UE 120b. Similarly, an obstruction between UE 120b and repeater 160a blocks or otherwise reduces the quality of a link between the repeater 160a and the UE 120b. However, no obstructions or fewer obstructions exist between repeater 160b and UE 120b, and, as such, it is possible that communications between repeater 160b and UE 120b will have a higher quality than communications between network node 110 and UE 120b or between repeater 160a and UE 120b. Furthermore, the millimeter wave repeater 160 described herein may be a layer 1 or an analog millimeter wave repeater, which is associated with lower cost, less processing, and lower latency than a layer 2 or layer 3 repeater.

A millimeter wave repeater 160 (sometimes referred to herein as a repeater 160) may perform directional communication by using beamforming to communicate with a network node 110 via a first beam pair (e.g., a backhaul beam pair over a backhaul link with the network node 110) and to communicate with a UE 120 via a second beam pair (e.g., an access beam pair over an access link with the UE 120). For example, in example 400, repeater 160a can communicate with network node 110 via a first beam pair and can communicate with UE 120a via a second beam pair. Similarly, repeater 160b can communicate with network node 110 via a first beam pair and can communicate with UE 120a via a second beam pair. A beam pair may refer to a transmit (Tx) beam used by a first device for transmission and a receive (Rx) beam used by a second device for reception of information transmitted by the first device via the Tx beam.

As shown by reference number 405, a network node 110 may use a beam sweeping procedure to transmit communications via multiple beams over time (e.g., using time division multiplexing (TDM)). As shown by reference number 410, the repeater 160a may receive a communication via an Rx beam of the repeater 160a. As shown by reference number 415, the repeater 160a may relay each received communication via multiple Tx beams of the repeater 160a (e.g., using TDM). As used herein, relaying a communication may refer to transmitting the received communication (e.g., after amplifying the received communication) without decoding the received communication and/or without modifying information carried in the received communication. Alternatively, relaying a received communication may refer to transmitting the received communication after decoding the received communication and/or modifying information carried in the received communication. In some aspects, a received communication may be relayed using a different time resource, a different frequency resource, and/or a different spatial resource (e.g., a different beam) to transmit the communication as compared to a time resource, a frequency resource, and/or a spatial resource in which the communication was received. As shown by reference number 420, a UE 120a may receive a relayed communication. In some aspects, the UE 120a may generate a communication to be transmitted to the network node 110. The UE 120a may then transmit the communication to the repeater 160a for relaying to the network node 110.

As indicated above, FIG. 4 is provided as an example. Other examples may differ from what is described with regard to FIG. 4.

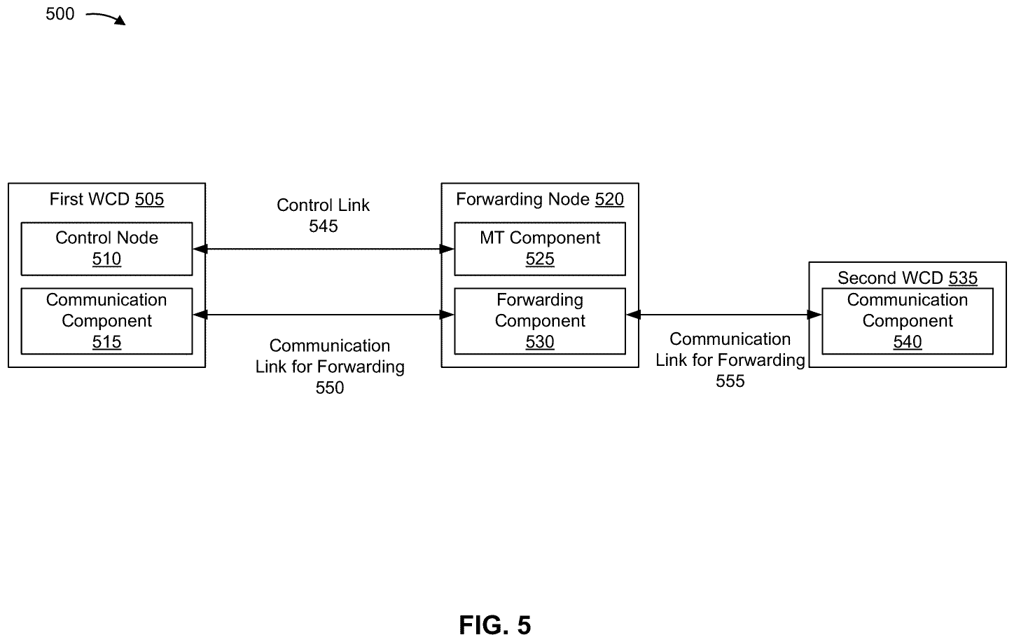

FIG. 5 is a diagram illustrating an example 500 of communicating using a forwarding node (e.g., a relay and/or a repeater, such as a millimeter wave repeater), in accordance with the present disclosure.

As shown in FIG. 5, a first WCD 505 (e.g., a network node 110 or a UE 120) may include a control node 510. The control node may be configured to exchange control information with connected forwarding nodes. For example, the control node 510 may be configured to provide control information to connected forwarding nodes to indicate one or more parameters for forwarding communications. The first WCD 505 may include a communication component 515 that is configured to communicate with one or more additional WCDs (e.g., via one or more connected forwarding nodes).

As further shown in FIG. 5, a forwarding node 520 may be connected to the first WCD 505. The forwarding node 520 may include a MT component 525 that is configured to communicate with the control node 510 of the first WCD 505. Communications associated with the MT component 525 terminate or initiate at the forwarding node 520, such as control information from and/or feedback to the first WCD 505. The forwarding node 520 may include a forwarding component 530 that is configured to receive and forward communications to and/or from the first WCD 505 (e.g., the communication component 515). The forwarding component 530 may be configured to operate based at least in part on control information received at the MT component 525.

In some examples, the forwarding node 520 may include an NCR that is configured to operate based at least in part on control information from the first WCD 505 (e.g., a network node and/or a control node of an associated network). In some examples, the MT component 525 may include an NCR-MT and the forwarding component 530 may include an NCR-Fwd (NCR forwarding component).

The forwarding node 520 may provide a wireless connection between the first WCD 505 and a second WCD 535. The second WCD 535 may include a communication component 540 for receiving from and/or transmitting to the forwarding node 520 (e.g., the forwarding component).

The control node 510 and the MT component 525 may establish a control link 545 through which the first WCD 505 may provide control information to the forwarding node 520. The control information may be used to control and/or configure operations of the forwarding component 530.

The communication component 515 may establish a communication link 550 for forwarding with the forwarding component 530. The communication component 540 may establish a communication link 555 for forwarding with the forwarding component 530. The communication links for forwarding may be based at least in part on the control information provided by the control node 510.

In some examples, the first WCD 505 may include a network node and the communication link 550 may be a backhaul link. The backhaul link may be a direct link or may include multiple hops to the network node. In some examples, the second WCD 535 may include a UE and the communication link 555 may be an access link.

As indicated above, FIG. 5 is provided as an example. Other examples may differ from what is described with regard to FIG. 5.

In some networks, forwarding nodes may be used to relay and/or repeat information between wireless communication devices. For example, some networks may operate in frequencies with increased propagation losses where a range of wireless transmissions is insufficient to establish direct communication links between WCDs. In this case, a forwarding node (e.g., a relay and/or a repeater) may receive communications from a first WCD and forward the communications to a second WCD. In this way, the first WCD and the second WCD may communicate via the forwarding node.

The forwarding node (e.g., a NCR) may establish a control link with the first WCD (e.g., a network node and/or a UE) through which the forwarding link receives control information. The control information indicates one or more parameters for forwarding, such as beamforming for a link between the forwarding node and a second WCD that is in communication with the first WCD (e.g., an access link or a sidelink), TDD, on-off controls, a power configuration, a frequency configuration for forwarding, and/or beamforming for a link between the forwarding node and the first WCD (e.g., a backhaul link or a sidelink). However, the control information may consume network resources and/or reduce a throughput of the forwarding node.

In some aspects described herein, a forwarding node may be configured to operate using a WCD-controlled operation mode. In some aspects, the WCD-controlled operation mode may be associated with an amount of control information that the forwarding node can identify without an indication from the first WCD. In some aspects, the forwarding node may select the WCD-controlled operation mode from a set of candidate WCD-controlled operation modes. For example, the forwarding node may select the WCD-controlled operation mode based at least in part on one or more parameters (e.g., values associated with the one or more parameters), such as channel conditions of a wireless link from the first WCD and the forwarding node, channel conditions of a wireless link from the forwarding node to the second WCD, mobility of the forwarding node, mobility of the first WCD, mobility of the second WCD in communication with the first WCD via the forwarding node, and/or a likelihood of success of autonomous identification of control information (e.g., identification of one or more elements of the control information without an indication of the one or more elements by the first WCD) by the forwarding node, among other examples.

The forwarding node may transmit an indication of the selection of the WCD-controlled operation mode to the first WCD. Based at least in part on the WCD-controlled operation mode, the first WCD may transmit a set of information elements of control information that is based at least in part on the WCD-controlled operation mode (e.g., information elements included in the set of information elements is based at least in part on the WCD-controlled operation mode). The first WCD and the second WCD may communication via the forwarding node based at least in part on the WCD-controlled operation mode (e.g., based at least in part on using one or more information elements of control information that are selected and/or identified by the forwarding node without an indication from the first WCD). In this way, the forwarding node may select, based at least in part on parameters at the forwarding node, an amount of control information that the first WCD is to transmit to the forwarding node for operation in forwarding communications from the first WCD to the second WCD. Based at least in part on the amount of control information transmitted to the forwarding node (e.g., associated with the WCD-controlled operation mode) being indicated by the forwarding node, the amount of control information and associated consumption of network resources may be reduced. Additionally, or alternatively, the amount of reduction being selected by the forwarding node may reduce communication errors that may have otherwise been caused by inaccurate selection by the first WCD (e.g., inaccurate based at least in part on not having access to information observed at the forwarding node).

In some aspects, the forwarding node (e.g., a repeater) may determine whether and/or when the forwarding node supports an autonomous mode of operation (e.g., a WCD-controlled operation mode with at least one information element of control information selected without an indication of the at least one information element from the first WCD). In some aspects, the autonomous mode of operation may be related to any (combination) of (e.g., for access link beams), access link beamforming, time-division duplexing information (e.g., dynamic aspects such as downlink (e.g., only), uplink (e.g., only), full-duplex, an off state, and/or use of flexible resources), ON-OFF information (e.g., for forwarding), a power configuration, a frequency configuration (e.g., which passbands to forward or reject), and/or backhaul link beamforming, among other examples.

Determinations of the autonomous mode of operation (e.g., WCD-controlled operation mode) may be based on any backhaul and/or access channel conditions (e.g., signal strength and/or quality, among other examples), a mobility state of the forwarding node (e.g., a relative mobility state), a mobility state of the first WCD, a mobility state of the a second WCD, and/or a confidence of the forwarding node to autonomously identify control information, among other examples.

In some aspects, criteria (e.g., thresholds, observations, and/or averaging windows) may be configured to be associated with metrics used for determining the mode of operation. The criteria may be provided by a network node (e.g., the first WCD) and/or a control device (e.g., via an operation, administration, and management (OAM) link). The forwarding node may report the criteria to a network device (e.g., a network node and/or the first WCD). In some aspects, the criteria may be different for different spatial, frequency, and/or time domain resources.

The forwarding node may indicate to a network device (e.g., the WCD) whether and/or when the forwarding node supports the autonomous mode of operation. The indication may reuse a baseline capability report configuration. For example, the forwarding node may indicate that the forwarding node does not support reception of side control info (e.g., for access link beamforming info). In some aspects, the indication may use new signaling (e.g., downlink control information (DCI), MAC layer signaling, RRC signaling, and/or OAM signaling, among other examples). In some aspects, the first WCD may be configured to acknowledge the indication of the selection of the WCD-controlled operation mode (e.g., the autonomous mode of operation). In some aspects, if not acknowledged, the forwarding node may not adopt the selected WCD-controlled operation mode. In some aspects, the indication may be dynamic, semi-static, or semi-persistent. In some aspects, the indication may provide information such as what side control will be acquired autonomously (e.g., and for which control information is not required from the first WCD) and/or on which time, frequency, and/or spatial resources the repeater supports implementation of the WCD-controlled operation mode.

In some aspects, the WCD-controlled operation mode may include autonomous determination of a configuration that is selected from a pool of candidate configurations. For example, the forwarding node may autonomously select an access link beam between beam 1 and beam 2. The pool of candidates can be provided by the first WCD, a network node, and/or a control node (e.g., associated with OAM), among other examples. In some aspects, the forwarding node may use a fallback indication (e.g., a default WCD-controlled operation mode). For example, the forwarding node may support a fallback indication to change a mode of operation to a default mode of operation (e.g., to full NCR), and/or the network node may indicate the mode of operation for NCR (e.g., to reject the selected WCD-controlled operation mode).

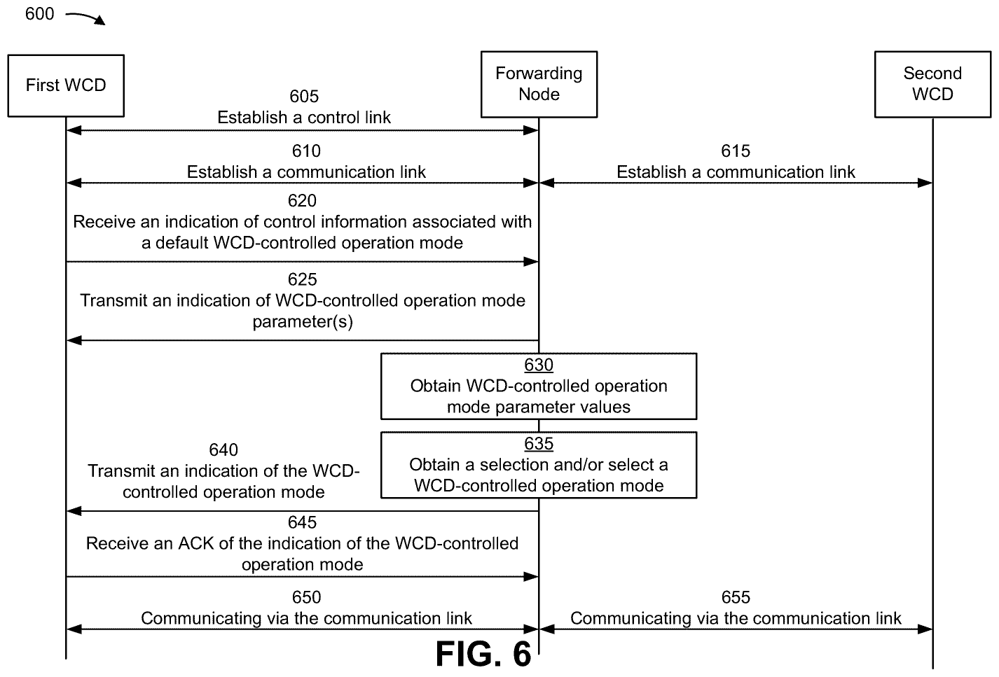

FIG. 6 is a diagram of an example 600 associated with communicating using a WCD-controlled operation mode for a forwarding node, in accordance with the present disclosure. As shown in FIG. 6, a first WCD (e.g., network node 110 or UE 120) may communication with a second WCD (e.g., UE 120) via a forwarding node (e.g., mmW repeater 160). In some aspects, the first WCD, the second WCD, and the forwarding node may be part of a wireless network (e.g., wireless network 100).

As shown by reference number 605, the first WCD and the forwarding node may establish a control link. For example, a control node of the first WCD and an MT component of the forwarding node may establish the control link. In some aspects, the first WCD may use the control link to transmit control information associated with operation of the forwarding node. For example, the first WCD may indicate one or more transmission parameters and or reception parameters, such as beamforming, power setting, sleep times, wake-up times, and/or other frequency-based parameters for communications, among other examples.

As shown by reference number 610, the forwarding node and the first node may establish a communication link. For example, the forwarding node may establish the communication link based at least in part on control information received via the control link.

As shown by reference number 615, the forwarding node and the second node may establish a communication link. For example, the forwarding node may establish the communication link with the second WCD based at least in part on control information received via the control link.

As shown by reference number 620, the forwarding node may receive, and the first WCD may transmit, an indication of control information associated with a default WCD-controlled operation mode. For example, the default WCD-controlled operation mode may be associated with non-autonomous identification of control information, where the forwarding node is not expected to identify control information without an indication from the first WCD. For example, the default WCD-controlled operation mode may include a configuration where the first WCD provides a maximum amount of control information to the forwarding node. In some aspects, the default WCD-controlled operation mode may be a fallback WCD-controlled operation mode when another WCD-controlled operation mode is not indicated and/or when the other WCD-controlled operation mode fails.

As shown by reference number 625, the forwarding node may transmit, and the first WCD may receive, an indication of one or more WCD-controlled operation mode parameters. For example, the one or more WCD-controlled operation mode parameters may include criteria for the forwarding node to select a WCD-controlled operation mode from a set of candidate WCD-controlled operation modes. In some aspects, the one or more WCD-controlled operation mode parameters include a threshold and/or a range of values associated with selection of the WCD-controlled operation mode. In some aspects, the forwarding node may transmit the indication of the one or more parameters to the first WCD so the first WCD is aware of conditions observed at the forwarding node based at least in part on an indication of a selection of the WCD-controlled operation mode.

In some aspects, the one or more WCD-controlled operation mode parameter values may include different values for different sets of time, frequency, and/or spatial resources. In some aspects, thresholds for selecting a WCD-controlled operation mode may be different for different sets of time, frequency, and/or spatial resources.

As shown by reference number 630, the forwarding node may obtain WCD-controlled operation mode parameters values. For example, the forwarding node may measure the WCD-controlled operation mode parameter values and/or may receive the WCD-controlled operation mode parameter values (e.g., from a device other than the first WCD associated with the control link).

As shown by reference number 635, the forwarding node may obtain a selection and/or select a WCD-controlled operation mode. For example, a control node (e.g., not co-located with the first WCD) associated with the forwarding node may identify and/or select the WCD-controlled operation mode based at least in part on the WCD-controlled operation mode parameter values. In some aspects, the control node may include a device (e.g., a network edge device) configured to train and/or apply a machine learning algorithm to select the WCD-controlled operation mode and to provide an indication of the selection to the forwarding node.

In some aspects, the forwarding node may select the WCD-controlled operation mode based at least in part on the WCD-controlled operation mode parameters values. For example, the WCD-controlled operation mode parameter values may be associated with the WCD-controlled operation mode. In some aspects, the forwarding node may train and/or apply a machine learning algorithm to select the WCD-controlled operation mode.

In some aspects, the forwarding node may select the WCD-controlled operation mode based at least in part on channel conditions of a wireless link from the first WCD and the forwarding node, channel conditions of a wireless link from the forwarding node to the second WCD that is in communication with the first WCD via the forwarding node, mobility of the forwarding node, mobility of the first WCD, and/or mobility of the second WCD. In some aspects, the forwarding node may select the WCD-controlled operation mode based at least in part on a likelihood of success (e.g., confidence of the forwarding node) of autonomous identification of control information by the forwarding node.

In some aspects, the forwarding node may use one or more parameters to select the WCD-controlled operation mode. For example, the forwarding node may use one or more parameters received from the WCD, one or more parameters configured (e.g., preconfigured) for the forwarding node, and/or one or more parameters received from a control node that is different from the WCD, among other examples. In some aspects, the one or more parameters are associated with thresholds of metrics associated with candidate WCD-controlled operation modes, ranges of the metrics associated with candidate WCD-controlled operation modes, observation windows for obtaining the metrics, and/or averaging functions for obtaining the metrics (e.g., weighting of metrics based on importance and/or time), among other examples.

In some aspects, the WCD-controlled operation mode may include an operation mode that is based at least in part on control information received by another device. For example, the WCD-controlled operation mode may be associated with control information identified by the forwarding node, control information received from a network control node that is different from the WCD, control information received from an additional WCD that is different from the WCD, and/or control information received from the WCD. For example, the WCD-controlled operation mode may include autonomous determination of a configuration of one or more communication parameters and/or reception of a configuration of one or more additional communication parameters from the first WCD via the control link. Different WCD-controlled operation mode may include different combinations of the one or more communication parameters that are autonomously determined or identified by the forwarding node or by another device (e.g., not the first WCD) without an indication of the one or more communication parameters from the first WCD.

In some aspects, the WCD-controlled operation mode is associated with forwarding node autonomous generation or reception of an indication from the first WCD-control information, such as beamforming information for a link between the forwarding node and an additional WCD that is in communication with the WCD, TDD information, on-off controls, a power configuration, a frequency configuration for forwarding, and/or beamforming for a link between the forwarding node and the WCD.

As shown by reference number 640, the forwarding node may transmit, and the first WCD may receive, an indication of the WCD-controlled operation mode. For example, the forwarding node may transmit an indication of the selection of the WCD-controlled operation mode. In some aspects, the forwarding node may transmit the indication via a capability report, uplink control information, a MAC control element (CE), RRC signaling, and/or OAM signaling, among other examples. For example, the forwarding node may transmit the indication via dynamic, semi-static, and/or semi-persistent types of indications.

In some aspects, the WCD-controlled operation mode is associated with a set of time resources, a set of frequency resources, and/or a set of spatial resources, among other examples. In this way, the first WCD may be aware of resources to use based at least in part on whether the forwarding node supports autonomous determination of a configuration. The WCD-controlled operation mode may be associated with a reduction or omission of control information received from the first WCD relative to a full NCR mode.

As shown by reference number 645, the first WCD may transmit an acknowledgment (ACK) of the indication of the WCD-controlled operation mode. In some aspects, the forwarding node may be configured to use the WCD-controlled operation mode based at least in part on receiving the ACK from the first WCD.

As shown by reference number 650, the forwarding node may communicate with the first WCD via the communication link. In some aspects, one or more parameters of the communication link is based at least in part on the WCD-controlled operation mode. In this way, the forwarding node may communicate with the first WCD based at least in part on the WCD-controlled operation mode.

As shown by reference number 655, the forwarding node may communicate with the second WCD via the communication link. In some aspects, one or more parameters of the communication link is based at least in part on the WCD-controlled operation mode. In this way, the forwarding node may communicate with the WCD based at least in part on the WCD-controlled operation mode.

In some aspects, communicating based at least in part on the WCD-controlled operation mode includes communicating using a configuration of one or more communication parameters that are selected without an indication of the selection from the first WCD.

In some aspects, the forwarding node may communicate with the first WCD and the second WCD based at least in part on receiving a set of information elements of control information, with a first subset of information elements received from the first WCD and/or a second subset of information elements autonomously identified by the forwarding node (and/or received outside of the control link) based at least in part on the WCD-controlled operation mode.

In some aspects, the forwarding node may communicate using the default WCD-controlled operation mode before and/or after communicating based at least in part on the WCD-controlled operation mode.

Based at least in part on an amount of control information transmitted to the forwarding node (e.g., associated with the WCD-controlled operation mode) being indicated by the forwarding node, the amount of control information and associated consumption of network resources may be reduced. Additionally, or alternatively, the amount of reduction being selected by the forwarding node may reduce communication errors that may have otherwise been caused by inaccurate selection by the first WCD (e.g., inaccurate based at least in part on not having access to information observed at the forwarding node).

As indicated above, FIG. 6 is provided as an example. Other examples may differ from what is described with respect to FIG. 6.

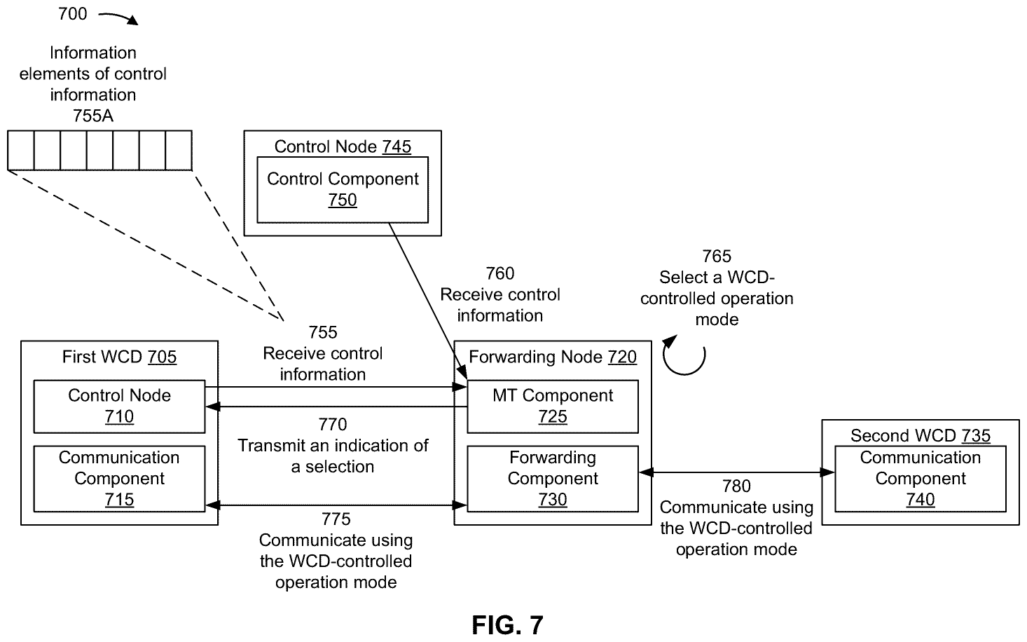

FIG. 7 is a diagram illustrating an example 700 of communicating using a forwarding node (e.g., a relay and/or a repeater, such as a millimeter wave repeater), in accordance with the present disclosure.

As shown in FIG. 7, a first WCD 705 (e.g., a network node 110 or a UE 120) may include a control node 710. The control node may be configured to exchange control information with connected forwarding nodes. For example, the control node 710 may be configured to provide control information to connected forwarding nodes to indicate one or more parameters for forwarding communications. The first WCD 705 may include a communication component 715 that is configured to communicate with one or more additional WCDs (e.g., via one or more connected forwarding nodes).

As further shown in FIG. 7, a forwarding node 720 may be connected to the first WCD 705. The forwarding node 720 may include an MT component 725 that is configured to communicate with the control node 710 of the first WCD 705. Communications associated with the MT component 725 terminate or initiate at the forwarding node 720, such as control information from and/or feedback to the first WCD 705. The forwarding node 720 may include a forwarding component 730 that is configured to receive and forward communications to and/or from the first WCD 705 (e.g., the communication component 715). The forwarding component 730 may be configured to operate based at least in part on control information received at the MT component 725.

In some examples, the forwarding node 720 may include an NCR that is configured to operate based at least in part on control information from the first WCD 705 (e.g., a network node and/or a control node of an associated network). In some examples, the MT component 725 may include an NCR-MT and the forwarding component 730 may include an NCR-Fwd (NCR forwarding component).

The forwarding node 720 may provide a wireless connection between the first WCD 705 and a second WCD 735. The second WCD 735 may include a communication component 740 for receiving from and/or transmitting to the forwarding node 720 (e.g., the forwarding component).

The forwarding node 720 may be associated with a control node 745 that is not co-located with the first WCD 705. For example, the control node 745 may be associated with an edge node of a wireless network and/or an application server. The control node 745 may include a control component 750 that is configured to assist the forwarding node 720 in identifying a WCD-controlled operation mode and/or information elements of control information that the forwarding node may identify outside of a control link with the control node 710 of the first WCD 705.

In some examples, the first WCD 705 may include a network node and may be connected to the forwarding node 720 via a backhaul link. The backhaul link may be a direct link or may include multiple hops to the network node. In some examples, the second WCD 735 may include a UE and a communication link between the second WCD 735 and the forwarding node 720 may be an access link.

As shown by reference number 755, the forwarding node 720 may receive control information from the first WCD 705. For example, the control node 710 may provide the control information to the MT component 725. The control information may be associated with operation of the forwarding node 720 in forwarding communications between the first WCD 705 and the second WCD 735. In some aspects, the control information may initially include all information elements of the control information, and the forwarding node may not yet support autonomous determination of the information elements of the control information.

As shown in FIG. 7, the control information may include information elements 755A of control information. The information elements of the control information may be associated with different control parameters for forwarding communications. The information elements may include one or more fields to indicate the different control parameters. In some aspects, the control parameters may include, for example, beamforming for a link between the forwarding node 720 and the second WCD 735, TDD information, on-off controls, a power configuration for forwarding communications (e.g., to the first WCD 705 or to the second WCD 735), a frequency configuration for forwarding, and/or beamforming information for a link between the forwarding node 720 and the first WCD 705.

As shown by reference number 760, the forwarding node may receive control information from the control node. For example, the control component 750 may provide the control information to the MT component 725. Based at least in part on the control node 745 providing control information (e.g., based at least in part on a machine learning or other decision making algorithm for identifying one or more information elements of the control information for subsequent communications), the forwarding node 720 may identify the one or more information elements of the control information without receiving an indication of the one or more information elements from the control node 710 at the first WCD 705. In some aspects, the forwarding node 720 may not communicate with the control node 745 (e.g., the control node 745 may be omitted and/or may not participate in selection of a WCD-controlled operation mode for the forwarding node 720).

As shown by reference number 765, the forwarding node 720 may select a WCD-controlled operation mode for communicating with the first WCD 705 and/or the second WCD 735. For example, the forwarding node may select the WCD-controlled operation mode based at least in part on channel conditions, mobility of the WCDs 705 or 735 and/or the forwarding node 720, and/or a likelihood of success in correctly identifying the information elements of the control information without an indication from the first WCD 705, among other examples.

As shown by reference number 770, the forwarding node may transmit an indication of the selection of the WCD-controlled operation mode to the first WCD 705. In this way, the first WCD 705 may be aware of the selection.

As shown by reference number 775, the forwarding node 720 and the first WCD 705 may communicate using the WCD-controlled operation mode. As shown by reference number 780, the forwarding node 720 and the second WCD 735 may communicate using the WCD-controlled operation mode.

As indicated above, FIG. 7 is provided as an example. Other examples may differ from what is described with regard to FIG. 7.

FIG. 8 is a diagram illustrating an example process 800 performed, for example, by a forwarding node, in accordance with the present disclosure. Example process 800 is an example where the forwarding node (e.g., forwarding node 720, network node 110, and/or mmW repeater 160) performs operations associated with communication using a WCD-controlled operation mode for a forwarding node.

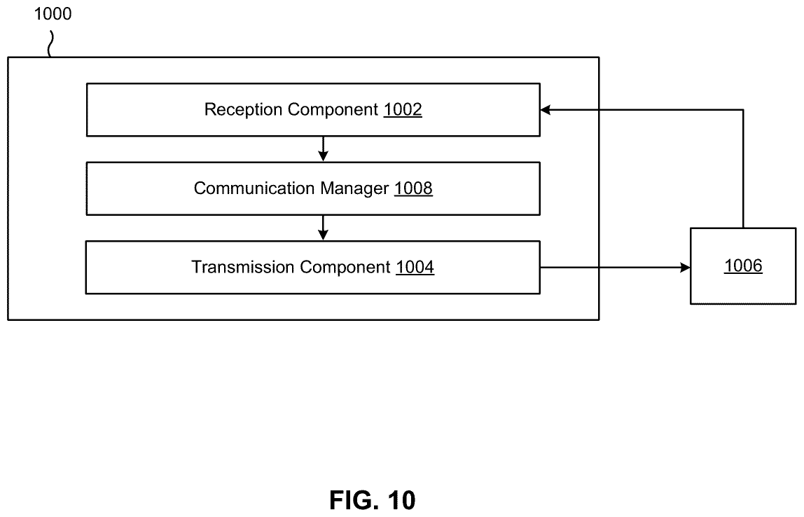

As shown in FIG. 8, in some aspects, process 800 may include transmitting an indication of a selection of a WCD-controlled operation mode (block 810). For example, the forwarding node (e.g., using communication manager 140 or 150 and/or transmission component 1004, depicted in FIG. 10) may transmit an indication of a selection of a WCD-controlled operation mode, as described above.

As further shown in FIG. 8, in some aspects, process 800 may include communicating with a WCD based at least in part on the WCD-controlled operation mode (block 820). For example, the forwarding node (e.g., using communication manager 140 or 150, reception component 1002, and/or transmission component 1004, depicted in FIG. 10) may communicate with a WCD based at least in part on the WCD-controlled operation mode, as described above.

Process 800 may include additional aspects, such as any single aspect or any combination of aspects described below and/or in connection with one or more other processes described elsewhere herein.

In a first aspect, the WCD-controlled operation mode comprises an operation mode for communications based at least in part on one or more of controlling information identified by the forwarding node, controlling information received from a network control node that is different from the WCD, controlling information received from an additional WCD that is different from the WCD, or controlling information received from the WCD.

In a second aspect, alone or in combination with the first aspect, the selection of the WCD-controlled operation mode is based at least in part on one or more of channeling conditions of a wireless link from the WCD and the forwarding node, channeling conditions of a wireless link from the forwarding node to an additional WCD that is in communication with the WCD via the forwarding node, mobility of the forwarding node, mobility of the WCD, mobility of the additional WCD, or a likelihood of success of autonomous identification of control information by the forwarding node.

In a third aspect, alone or in combination with one or more of the first and second aspects, the selection of the WCD-controlled operation mode is based at least in part on one or more of one or more parameters received from the WCD, one or more parameters configured for the forwarding node, or one or more parameters received from a control node that is different from the WCD.

In a fourth aspect, alone or in combination with one or more of the first through third aspects, the one or more parameters are associated with one or more of thresholds of metrics associated with candidate WCD-controlled operation modes, ranges of the metrics associated with candidate WCD-controlled operation modes, windows for obtaining the metrics, or averaging functions for obtaining the metrics.

In a fifth aspect, alone or in combination with one or more of the first through fourth aspects, process 800 includes transmitting an indication of the one or more parameters.

In a sixth aspect, alone or in combination with one or more of the first through fifth aspects, the one or more parameters configured for the forwarding node are preconfigured.

In a seventh aspect, alone or in combination with one or more of the first through sixth aspects, the selection of the WCD-controlled operation mode is associated with one or more of a set of time resources, a set of frequency resources, or a set of spatial resources.

In an eighth aspect, alone or in combination with one or more of the first through seventh aspects, the WCD-controlled operation mode is associated with a reduction or omission of control information received from the WCD.

In a ninth aspect, alone or in combination with one or more of the first through eighth aspects, the control information is associated with one or more of beamforming for a link between the forwarding node and an additional WCD that is in communication with the WCD, TDD, on-off controls, a power configuration, a frequency configuration for forwarding, or beamforming for a link between the forwarding node and the WCD.

In a tenth aspect, alone or in combination with one or more of the first through ninth aspects, transmitting the indication of the selection of the WCD-controlled operation mode comprises transmitting the indication of the selection via one or more of a capability report, uplink control information, a MAC CE, RRC signaling, or OAM signaling.

In an eleventh aspect, alone or in combination with one or more of the first through tenth aspects, process 800 includes receiving an acknowledgement of the indication of the selection of the WCD-controlled operation mode, wherein communicating with the WCD based at least in part on the WCD-controlled operation mode is based at least in part on receiving the acknowledgement.

In a twelfth aspect, alone or in combination with one or more of the first through eleventh aspects, communicating with the WCD based at least in part on the WCD-controlled operation mode comprises communicating using a configuration of one or more communication parameters that are selected without an indication of the selection from the WCD.

In a thirteenth aspect, alone or in combination with one or more of the first through twelfth aspects, the selection of the one or more communication parameters comprises selection of the one or more communication parameters from a set of candidate communication parameters indicated to the WCD, or selection of the one or more communication parameters from a set of candidate communication parameters indicated by the WCD or a control node.

In a fourteenth aspect, alone or in combination with one or more of the first through thirteenth aspects, the WCD-controlled operation mode is a candidate WCD-controlled operation mode of a set of candidate WCD-controlled operation modes.

In a fifteenth aspect, alone or in combination with one or more of the first through fourteenth aspects, process 800 includes receiving an indication of control information associated with a default WCD-controlled operation mode, and communicating, before or after communicating based at least in part on the WCD-controlled operation mode, with the WCD based at least in part on the default WCD-controlled operation mode.

In a sixteenth aspect, alone or in combination with one or more of the first through fifteenth aspects, process 800 includes receiving a set of information elements of control information based at least in part on the WCD-controlled operation mode.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a WCD, in accordance with the present disclosure. Example process 900 is an example where the WCD (e.g., UE 120 or network node 110) performs operations associated with WCD-controlled operation mode.

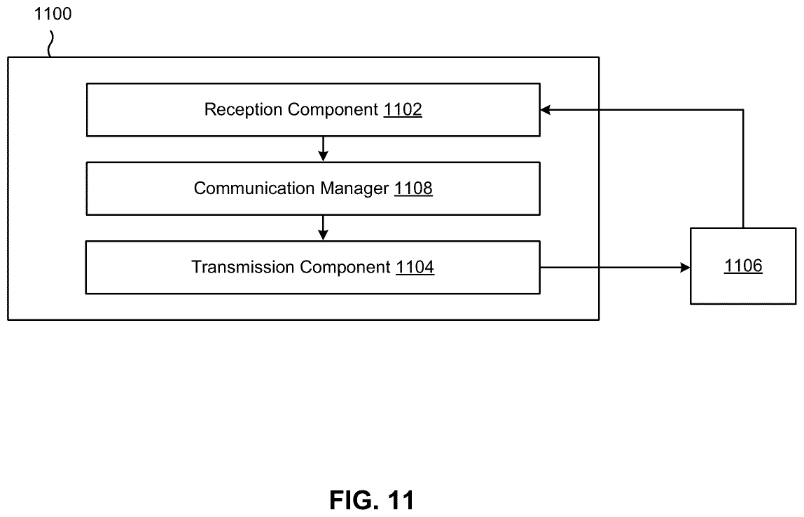

As shown in FIG. 9, in some aspects, process 900 may include receiving an indication of a selection of a WCD-controlled operation mode associated with a forwarding node (block 910). For example, the WCD (e.g., using communication manager 140 or 150 and/or reception component 1102, depicted in FIG. 11) may receive an indication of a selection of a WCD-controlled operation mode associated with a forwarding node, as described above.

As further shown in FIG. 9, in some aspects, process 900 may include communicating, via the forwarding node, with an additional WCD based at least in part on the WCD-controlled operation mode (block 920). For example, the WCD (e.g., using communication manager 140 or 150, reception component 1102, and/or transmission component 1104, depicted in FIG. 11) may communicate, via the forwarding node, with an additional WCD based at least in part on the WCD-controlled operation mode, as described above.

Process 900 may include additional aspects, such as any single aspect or any combination of aspects described below and/or in connection with one or more other processes described elsewhere herein.

In a first aspect, the WCD-controlled operation mode comprises an operation mode for communications based at least in part on one or more of controlling information identified by the forwarding node, controlling information received from a network control node that is different from the WCD, controlling information received from an additional WCD that is different from the WCD, or controlling information received from the WCD.

In a second aspect, alone or in combination with the first aspect, the selection of the WCD-controlled operation mode is based at least in part on one or more of channeling conditions of a wireless link from the WCD and the forwarding node, channeling conditions of a wireless link from the forwarding node to the additional WCD, mobility of the forwarding node, mobility of the WCD, mobility of the additional WCD in communication with the WCD via the forwarding node, or a likelihood of success of autonomous identification of control information by the forwarding node.

In a third aspect, alone or in combination with one or more of the first and second aspects, the selection of the WCD-controlled operation mode is based at least in part on one or more of one or more parameters transmitted by the WCD, one or more parameters configured for the forwarding node, or one or more parameters received from a control node that is different from the WCD.

In a fourth aspect, alone or in combination with one or more of the first through third aspects, the one or more parameters are associated with one or more of thresholds of metrics associated with candidate WCD-controlled operation modes, ranges of the metrics associated with candidate WCD-controlled operation modes, windows for obtaining the metrics, or averaging functions for obtaining the metrics.

In a fifth aspect, alone or in combination with one or more of the first through fourth aspects, process 900 includes receiving an indication of the one or more parameters.

In a sixth aspect, alone or in combination with one or more of the first through fifth aspects, the one or more parameters configured for the forwarding node are preconfigured.

In a seventh aspect, alone or in combination with one or more of the first through sixth aspects, the selection of the WCD-controlled operation mode is associated with one or more of a set of time resources, a set of frequency resources, or a set of spatial resources.

In an eighth aspect, alone or in combination with one or more of the first through seventh aspects, the WCD-controlled operation mode is associated with a reduction or omission of control information transmitted by the WCD.

In a ninth aspect, alone or in combination with one or more of the first through eighth aspects, the control information is associated with one or more of beamforming for a link between the forwarding node and an additional WCD that is in communication with the WCD, TDD, on-off controls, a power configuration, a frequency configuration for forwarding, or beamforming for a link between the forwarding node and the WCD.

In a tenth aspect, alone or in combination with one or more of the first through ninth aspects, receiving the indication of the selection of the WCD-controlled operation mode comprises receiving the indication of the selection via one or more of a capability report, uplink control information, a MAC CE, RRC signaling, or OAM signaling.

In an eleventh aspect, alone or in combination with one or more of the first through tenth aspects, process 900 includes transmitting an acknowledgement of the indication of the selection of the WCD-controlled operation mode, wherein communicating with the additional WCD based at least in part on the WCD-controlled operation mode is based at least in part on transmitting the acknowledgement.

In a twelfth aspect, alone or in combination with one or more of the first through eleventh aspects, communicating with the additional WCD based at least in part on the WCD-controlled operation mode comprises communicating based at least in part on the forwarding node using a configuration of one or more communication parameters that are selected without an indication of the selection from the WCD.

In a thirteenth aspect, alone or in combination with one or more of the first through twelfth aspects, the selection of the one or more communication parameters comprises selection of the one or more communication parameters from a set of candidate communication parameters indicated to the WCD, or selection of the one or more communication parameters from a set of candidate communication parameters indicated by the WCD or a control node.

In a fourteenth aspect, alone or in combination with one or more of the first through thirteenth aspects, the WCD-controlled operation mode is a candidate WCD-controlled operation mode of a set of candidate WCD-controlled operation modes.

In a fifteenth aspect, alone or in combination with one or more of the first through fourteenth aspects, process 900 includes transmitting an indication of one or more parameters of a default WCD-controlled operation mode, and communicating, before or after communicating based at least in part on the WCD-controlled operation mode, with the additional WCD based at least in part on the forwarding node using the default WCD-controlled operation mode.

In a sixteenth aspect, alone or in combination with one or more of the first through fifteenth aspects, process 900 includes transmitting a set of information elements of control information based at least in part on the WCD-controlled operation mode.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a forwarding node, or a forwarding node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140 or 150). The communication manager 1008 may include an identification component, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the forwarding node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the forwarding node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the forwarding node described in connection with FIG. 2. In some aspects, the transmission component 1004 may be co-located with the reception component 1002 in a transceiver.

The transmission component 1004 may transmit an indication of a selection of a WCD-controlled operation mode. The reception component 1002 and/or the transmission component 1004 may communicate with a WCD based at least in part on the WCD-controlled operation mode.

The transmission component 1004 may transmit an indication of the one or more parameters.

The reception component 1002 may receive an acknowledgement of the indication of the selection of the WCD-controlled operation mode wherein communicating with the WCD based at least in part on the WCD-controlled operation mode is based at least in part on receiving the acknowledgement.

The reception component 1002 may receive an indication of control information associated with a default WCD-controlled operation mode.

The reception component 1002 and/or the transmission component 1004 may communicate, before or after communicating based at least in part on the WCD-controlled operation mode, with the WCD based at least in part on the default WCD-controlled operation mode.

The reception component 1002 may receive a set of information elements of control information based at least in part on the WCD-controlled operation mode.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a WCD, or a WCD may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 140 or 150). The communication manager 1108 may include an identification component, among other examples.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the WCD described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the WCD described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the WCD described in connection with FIG. 2. In some aspects, the transmission component 1104 may be co-located with the reception component 1102 in a transceiver.

The reception component 1102 may receive an indication of a selection of a WCD-controlled operation mode associated with a forwarding node. The reception component 1102 and/or the transmission component 1104 may communicate, via the forwarding node, with an additional WCD based at least in part on the WCD-controlled operation mode.

The reception component 1102 may receive an indication of the one or more parameters.

The transmission component 1104 may transmit an acknowledgement of the indication of the selection of the WCD-controlled operation mode wherein communicating with the additional WCD based at least in part on the WCD-controlled operation mode is based at least in part on transmitting the acknowledgement.

The transmission component 1104 may transmit an indication of one or more parameters of a default WCD-controlled operation mode.

The reception component 1102 and/or the transmission component 1104 may communicate, before or after communicating based at least in part on the WCD-controlled operation mode, with the additional WCD based at least in part on the forwarding node using the default WCD-controlled operation mode.

The transmission component 1104 may transmit a set of information elements of control information based at least in part on the WCD-controlled operation mode.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

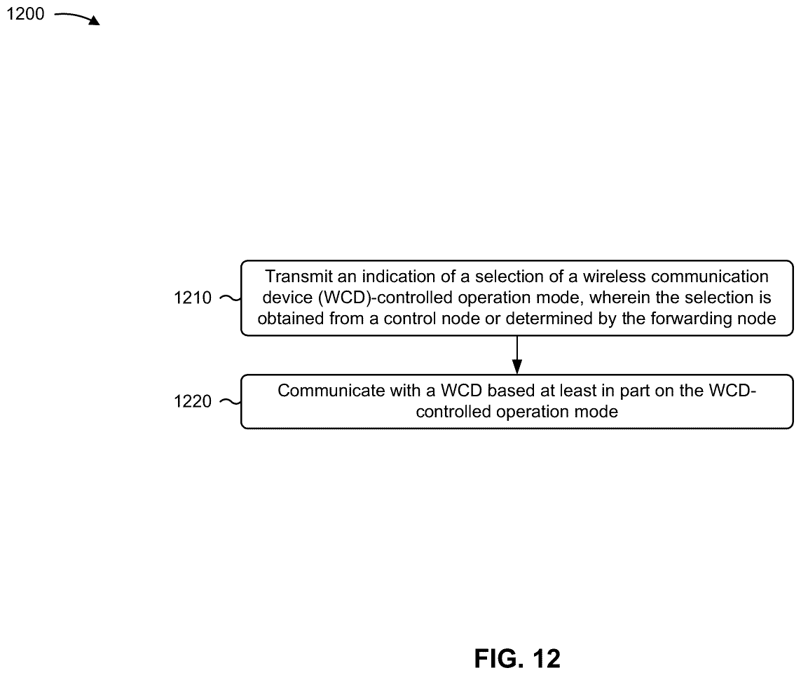

FIG. 12 is a diagram illustrating an example process 1200 performed, for example, at a forwarding node or an apparatus of a forwarding node, in accordance with the present disclosure. Example process 1200 is an example where the forwarding node (e.g., forwarding node 720, network node 110, and/or mmW repeater 160) performs operations associated with communication using a WCD-controlled operation mode for a forwarding node.

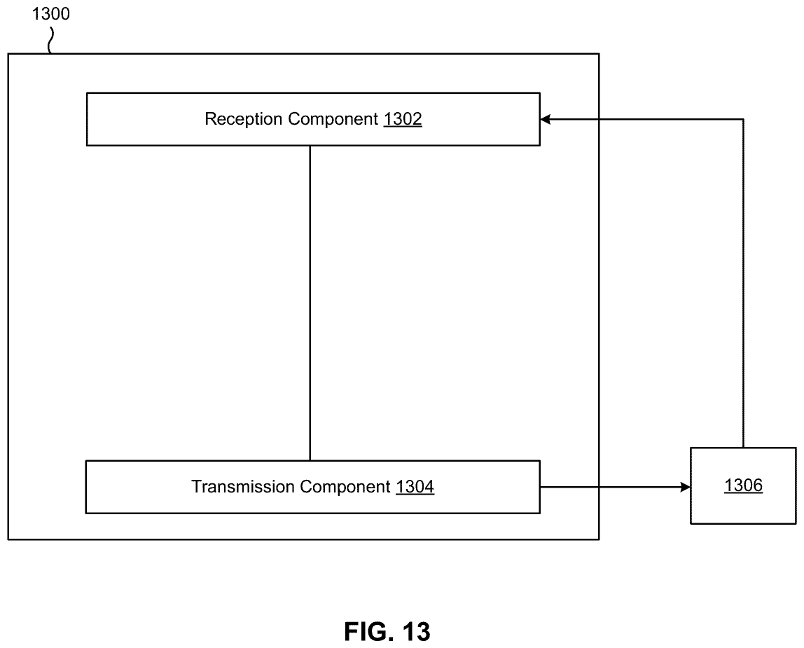

As shown in FIG. 12, in some aspects, process 1200 may include transmitting an indication of a selection of a WCD-controlled operation mode, wherein the selection is obtained from a control node or determined by the forwarding node (block 1210). For example, the forwarding node (e.g., using transmission component 1304, depicted in FIG. 13) may transmit an indication of a selection of a WCD-controlled operation mode, wherein the selection is obtained from a control node or determined by the forwarding node, as described above.

As further shown in FIG. 12, in some aspects, process 1200 may include communicating with a WCD based at least in part on the WCD-controlled operation mode (block 1220). For example, the forwarding node (e.g., using reception component 1302 and/or transmission component 1304, depicted in FIG. 13) may communicate with a WCD based at least in part on the WCD-controlled operation mode, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a forwarding node, or a forwarding node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 6-7. Additionally, or alternatively, the apparatus 1300 may be configured to perform one or more processes described herein, such as process 1200 of FIG. 12. In some aspects, the apparatus 1300 and/or one or more components shown in FIG. 13 may include one or more components of the forwarding node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the forwarding node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, one or more memories, or a combination thereof, of the forwarding node described in connection with FIG. 2. In some aspects, the transmission component 1304 may be co-located with the reception component 1302 in one or more transceivers.

The transmission component 1304 may transmit an indication of a selection of a WCD-controlled operation mode, wherein the selection is obtained from a control node or determined by the forwarding node. The reception component 1302 and/or the transmission component 1304 may communicate with a WCD based at least in part on the WCD-controlled operation mode.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

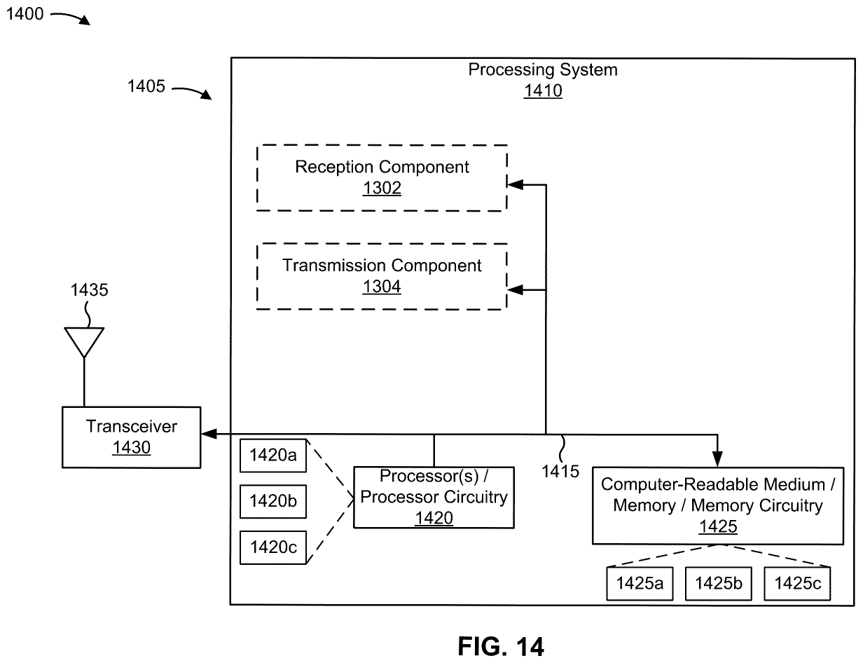

FIG. 14 is a diagram illustrating an example 1400 of a hardware implementation for an apparatus 1405 employing a processing system 1410, in accordance with the present disclosure. The apparatus 1405 may be a forwarding node or may be at (e.g., included in) a forwarding node.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor (or processing circuitry) 1420, the illustrated components, and the computer-readable medium/memory (or memory circuitry) 1425. The processor 1420 may include multiple processors, such as processor 1420a, memory 1420b, and memory 1420c. The memory 1425 may include multiple memories, such as memory 1425a, memory 1425b, and memory 1425c. The bus 1415 may also link various other circuits, such as timing sources, peripherals, voltage regulators, and/or power management circuits.

The processing system 1410 may be coupled to one or more transceivers 1430. A transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes one or more processors 1420 coupled to a computer-readable medium/memory 1425. A processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may include one or more memories, such as the memory 282, and/or may include one or more processors, such as at least one of the TX MIMO processor 266, the RX processor 258, and/or the controller/processor 280. In some aspects, the processing system 1410 may include one or more memories, such as the memory 242, and/or may include one or more processors, such as at least one of the TX MIMO processor 216, the RX processor 238, and/or the controller/processor 240.

In some aspects, the apparatus 1405 for wireless communication includes means for transmitting an indication of a selection of a WCD-controlled operation mode, wherein the selection is obtained from a control node or determined by the forwarding node; and communicating with a WCD based at least in part on the WCD-controlled operation mode. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein. As described elsewhere herein, the processing system 1410 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 14 is provided as an example. Other examples may differ from what is described in connection with FIG. 14.

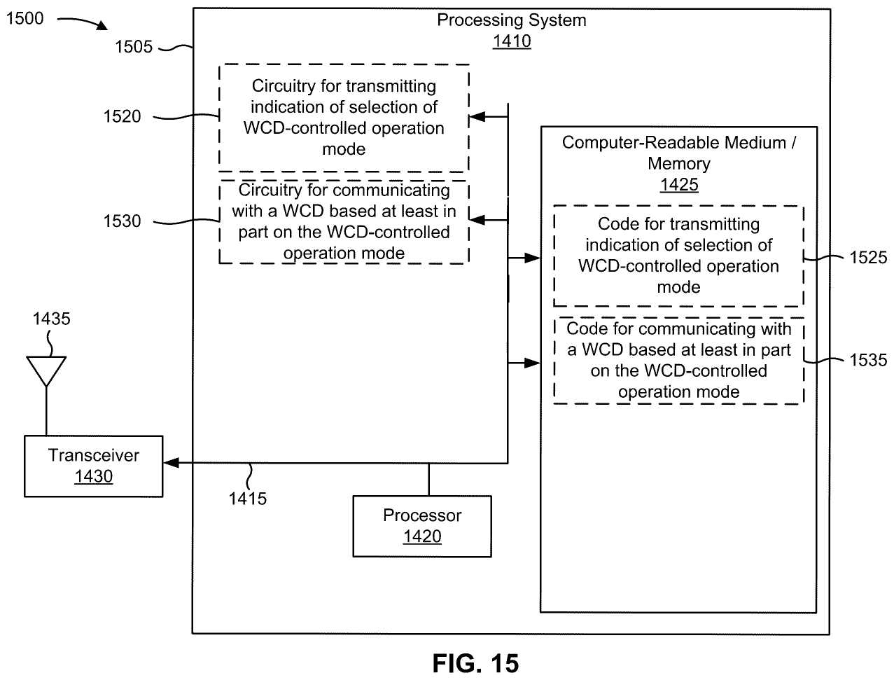

FIG. 15 is a diagram illustrating an example 1500 of an implementation of code and circuitry for an apparatus 1505, in accordance with the present disclosure. The circuitry may include processing circuitry and memory circuitry. The apparatus 1505 may be a forwarding node, or a forwarding node may include the apparatus 1505.

As shown in FIG. 15, the apparatus 1505 may include circuitry for transmitting an indication of a selection of a WCD-controlled operation mode, wherein the selection is obtained from a control node or determined by the forwarding node (circuitry 1520). For example, the circuitry 1520 may enable the apparatus 1505 to transmit an indication of a selection of a WCD-controlled operation mode, wherein the selection is obtained from a control node or determined by the forwarding node.

As shown in FIG. 15, the apparatus 1505 may include, stored in computer-readable medium 1425, code for transmitting an indication of a selection of a WCD-controlled operation mode, wherein the selection is obtained from a control node or determined by the forwarding node (code 1525). For example, the code 1525, when executed by processor 1420, may cause processor 1420 to cause transceiver 1430 to transmit an indication of a selection of a WCD-controlled operation mode, wherein the selection is obtained from a control node or determined by the forwarding node.

As shown in FIG. 15, the apparatus 1505 may include circuitry for communicating with a WCD based at least in part on the WCD-controlled operation mode (circuitry 1530). For example, the circuitry 1530 may enable the apparatus 1505 to communicate with a WCD based at least in part on the WCD-controlled operation mode.

As shown in FIG. 15, the apparatus 1505 may include, stored in computer-readable medium 1425, code for communicating with a WCD based at least in part on the WCD-controlled operation mode (code 1535). For example, the code 1535, when executed by processor 1420, may cause processor 1420 to cause transceiver 1430 to communicate with a WCD based at least in part on the WCD-controlled operation mode.

FIG. 15 is provided as an example. Other examples may differ from what is described in connection with FIG. 15.

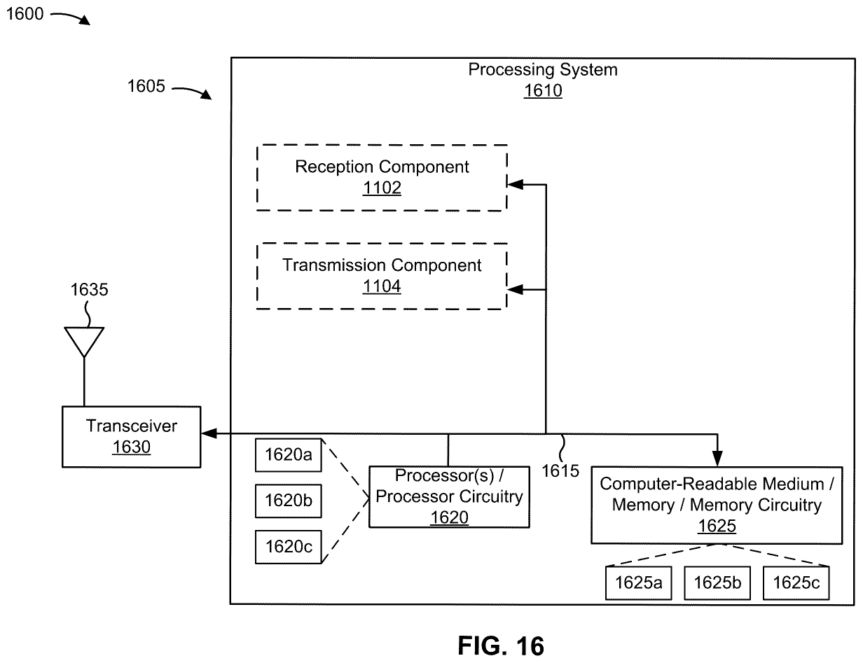

FIG. 16 is a diagram illustrating an example 1600 of a hardware implementation for an apparatus 1605 employing a processing system 1610, in accordance with the present disclosure. The apparatus 1605 may be a WCD or may be at (e.g., included in) a WCD.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor (or processing circuitry) 1620, the illustrated components, and the computer-readable medium/memory (or memory circuitry) 1625. The processor 1620 may include multiple processors, such as processor 1620a, memory 1620b, and memory 1620c. The memory 1625 may include multiple memories, such as memory 1625a, memory 1625b, and memory 1625c. The bus 1615 may also link various other circuits, such as timing sources, peripherals, voltage regulators, and/or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1102. In addition, the transceiver 1630 receives information from the processing system 1610, specifically the transmission component 1104, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the UE 120 and may include one or more memories, such as the memory 282, and/or may include one or more processors, such as at least one of the TX MIMO processor 266, the RX processor 258, and/or the controller/processor 280. In some aspects, the processing system 1610 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 1605 for wireless communication includes means for receiving an indication of a selection of a WCD-controlled operation mode associated with a forwarding node; and/or means for communicating, via the forwarding node, with an additional WCD based at least in part on the WCD-controlled operation mode. The aforementioned means may be one or more of the aforementioned components of the processing system 1610 of the apparatus 1605 configured to perform the functions recited by the aforementioned means. As described elsewhere herein, the processing system 1610 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein. As described elsewhere herein, the processing system 1610 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 16 is provided as an example. Other examples may differ from what is described in connection with FIG. 16.

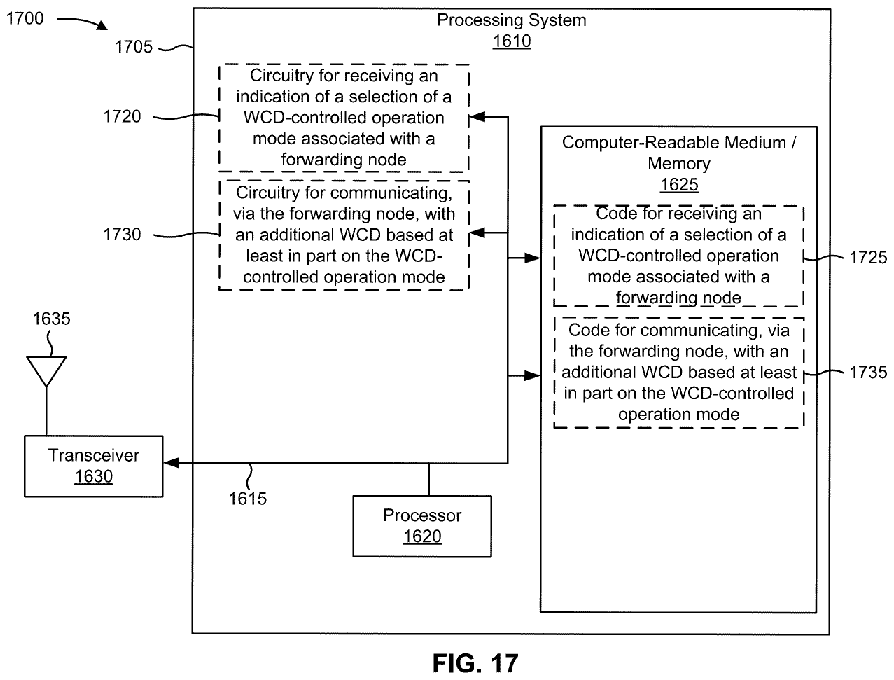

FIG. 17 is a diagram illustrating an example 1700 of an implementation of code and circuitry for an apparatus 1705, in accordance with the present disclosure. The circuitry may include processing circuitry and memory circuitry. The apparatus 1705 may be a WCD, or a WCD may include the apparatus 1705.

As shown in FIG. 17, the apparatus 1705 may include circuitry for receiving an indication of a selection of a WCD-controlled operation mode associated with a forwarding node (circuitry 1720). For example, the circuitry 1720 may enable the apparatus 1705 to receive an indication of a selection of a WCD-controlled operation mode associated with a forwarding node.

As shown in FIG. 17, the apparatus 1705 may include, stored in computer-readable medium 1625, code for receiving an indication of a selection of a WCD-controlled operation mode associated with a forwarding node (code 1725). For example, the code 1725, when executed by processor 1620, may cause processor 1620 to cause transceiver 1630 to receive an indication of a selection of a WCD-controlled operation mode associated with a forwarding node.

As shown in FIG. 17, the apparatus 1705 may include circuitry for communicating, via the forwarding node, with an additional WCD based at least in part on the WCD-controlled operation mode (circuitry 1730). For example, the circuitry 1730 may enable the apparatus 1705 to communicate, via the forwarding node, with an additional WCD based at least in part on the WCD-controlled operation mode.

As shown in FIG. 17, the apparatus 1705 may include, stored in computer-readable medium 1625, code for communicating, via the forwarding node, with an additional WCD based at least in part on the WCD-controlled operation mode (code 1735). For example, the code 1735, when executed by processor 1620, may cause processor 1620 to cause transceiver 1630 to communicate, via the forwarding node, with an additional WCD based at least in part on the WCD-controlled operation mode.

FIG. 17 is provided as an example. Other examples may differ from what is described in connection with FIG. 17.

The following provides an overview of some Aspects of the present disclosure:
Aspect 1: A method of wireless communication performed at a forwarding node, comprising: transmitting an indication of a selection of a wireless communication device (WCD) controlled operation mode; and communicating with a WCD based at least in part on the WCD-controlled operation mode.
Aspect 2: The method of Aspect 1, wherein the WCD-controlled operation mode comprises an operation mode for communications based at least in part on one or more of: control information identified by the forwarding node, control information received from a network control node that is different from the WCD, control information received from an additional WCD that is different from the WCD, or control information received from the WCD.
Aspect 3: The method of any of Aspects 1-2, wherein the selection of the WCD-controlled operation mode is based at least in part on one or more of: channel conditions of a wireless link from the WCD and the forwarding node, channel conditions of a wireless link from the forwarding node to an additional WCD that is in communication with the WCD via the forwarding node, mobility of the forwarding node, mobility of the WCD, mobility of the additional WCD, or a likelihood of success of autonomous identification of control information by the forwarding node.
Aspect 4: The method of any of Aspects 1-3, wherein the selection of the WCD-controlled operation mode is based at least in part on one or more of: one or more parameters received from the WCD, one or more parameters configured for the forwarding node, or one or more parameters received from a control node that is different from the WCD.
Aspect 5: The method of Aspect 4, wherein the one or more parameters are associated with one or more of: thresholds of metrics associated with candidate WCD-controlled operation modes, ranges of the metrics associated with candidate WCD-controlled operation modes, observation windows for obtaining the metrics, or averaging functions for obtaining the metrics.
Aspect 6: The method of Aspect 4, further comprising: transmitting an indication of the one or more parameters.
Aspect 7: The method of Aspect 4, wherein the one or more parameters configured for the forwarding node are preconfigured.
Aspect 8: The method of any of Aspects 1-7, wherein the selection of the WCD-controlled operation mode is associated with one or more of: a set of time resources, a set of frequency resources, or a set of spatial resources.
Aspect 9: The method of any of Aspects 1-8, wherein the WCD-controlled operation mode is associated with a reduction or omission of control information received from the WCD.
Aspect 10: The method of Aspect 9, wherein the control information is associated with one or more of: beamforming for a link between the forwarding node and an additional WCD that is in communication with the WCD, time division duplexing (TDD), on-off controls, a power configuration, a frequency configuration for forwarding, or beamforming for a link between the forwarding node and the WCD.
Aspect 11: The method of any of Aspects 1-10, wherein transmitting the indication of the selection of the WCD-controlled operation mode comprises transmitting the indication of the selection via one or more of: a capability report, uplink control information, a medium access control (MAC) control element (CE), radio resource control (RRC) signaling, or operation, administration, and management (OAM) signaling.
Aspect 12: The method of any of Aspects 1-11, further comprising: receiving an acknowledgement of the indication of the selection of the WCD-controlled operation mode, wherein communicating with the WCD based at least in part on the WCD-controlled operation mode is based at least in part on receiving the acknowledgement.
Aspect 13: The method of any of Aspects 1-12, wherein communicating with the WCD based at least in part on the WCD-controlled operation mode comprises: communicating using a configuration of one or more communication parameters that are selected without an indication of the selection from the WCD.
Aspect 14: The method of Aspect 13, wherein the selection of the one or more communication parameters comprises: selection of the one or more communication parameters from a set of candidate communication parameters indicated to the WCD, or selection of the one or more communication parameters from a set of candidate communication parameters indicated by the WCD or a control node.
Aspect 15: The method of any of Aspects 1-14, wherein the WCD-controlled operation mode is a candidate WCD-controlled operation mode of a set of candidate WCD-controlled operation modes.
Aspect 16: The method of any of Aspects 1-15, further comprising: receiving an indication of control information associated with a default WCD-controlled operation mode, and communicating, before or after communicating based at least in part on the WCD-controlled operation mode, with the WCD based at least in part on the default WCD-controlled operation mode.
Aspect 17: The method of any of Aspects 1-16, further comprising: receiving a set of information elements of control information based at least in part on the WCD-controlled operation mode.
Aspect 18: A method of wireless communication performed at a wireless communication device (WCD), comprising: receiving an indication of a selection of a WCD-controlled operation mode associated with a forwarding node; and communicating, via the forwarding node, with an additional WCD based at least in part on the WCD-controlled operation mode.
Aspect 19: The method of Aspect 18, wherein the WCD-controlled operation mode comprises an operation mode for communications based at least in part on one or more of: control information identified by the forwarding node, control information received from a network control node that is different from the WCD, control information received from an additional WCD that is different from the WCD, or control information received from the WCD.
Aspect 20: The method of any of Aspects 18-19, wherein the selection of the WCD-controlled operation mode is based at least in part on one or more of: channel conditions of a wireless link from the WCD and the forwarding node, channel conditions of a wireless link from the forwarding node to the additional WCD, mobility of the forwarding node, mobility of the WCD, mobility of the additional WCD in communication with the WCD via the forwarding node, or a likelihood of success of autonomous identification of control information by the forwarding node.
Aspect 21: The method of any of Aspects 18-20, wherein the selection of the WCD-controlled operation mode is based at least in part on one or more of: one or more parameters transmitted by the WCD, one or more parameters configured for the forwarding node, or one or more parameters received from a control node that is different from the WCD.
Aspect 22: The method of Aspect 21, wherein the one or more parameters are associated with one or more of: thresholds of metrics associated with candidate WCD-controlled operation modes, ranges of the metrics associated with candidate WCD-controlled operation modes, observation windows for obtaining the metrics, or averaging functions for obtaining the metrics.
Aspect 23: The method of Aspect 21, further comprising: receiving an indication of the one or more parameters.
Aspect 24: The method of Aspect 21, wherein the one or more parameters configured for the forwarding node are preconfigured.
Aspect 25: The method of any of Aspects 18-24, wherein the selection of the WCD-controlled operation mode is associated with one or more of: a set of time resources, a set of frequency resources, or a set of spatial resources.
Aspect 26: The method of any of Aspects 18-25, wherein the WCD-controlled operation mode is associated with a reduction or omission of control information transmitted by the WCD.
Aspect 27: The method of Aspect 26, wherein the control information is associated with one or more of: beamforming for a link between the forwarding node and an additional WCD that is in communication with the WCD, time division duplexing (TDD), on-off controls, a power configuration, a frequency configuration for forwarding, or beamforming for a link between the forwarding node and the WCD.
Aspect 28: The method of any of Aspects 18-27, wherein receiving the indication of the selection of the WCD-controlled operation mode comprises receiving the indication of the selection via one or more of: a capability report, uplink control information, a medium access control (MAC) control element (CE), radio resource control (RRC) signaling, or operation, administration, and management (OAM) signaling.
Aspect 29: The method of any of Aspects 18-28, further comprising: transmitting an acknowledgement of the indication of the selection of the WCD-controlled operation mode, wherein communicating with the additional WCD based at least in part on the WCD-controlled operation mode is based at least in part on transmitting the acknowledgement.
Aspect 30: The method of any of Aspects 18-29, wherein communicating with the additional WCD based at least in part on the WCD-controlled operation mode comprises: communicating based at least in part on the forwarding node using a configuration of one or more communication parameters that are selected without an indication of the selection from the WCD.
Aspect 31: The method of Aspect 30, wherein the selection of the one or more communication parameters comprises: selection of the one or more communication parameters from a set of candidate communication parameters indicated to the WCD, or selection of the one or more communication parameters from a set of candidate communication parameters indicated by the WCD or a control node.
Aspect 32: The method of any of Aspects 18-31, wherein the WCD-controlled operation mode is a candidate WCD-controlled operation mode of a set of candidate WCD-controlled operation modes.
Aspect 33: The method of any of Aspects 18-32, further comprising: transmitting an indication of one or more parameters of a default WCD-controlled operation mode, and communicating, before or after communicating based at least in part on the WCD-controlled operation mode, with the additional WCD based at least in part on the forwarding node using the default WCD-controlled operation mode.
Aspect 34: The method of any of Aspects 18-33, further comprising: transmitting a set of information elements of control information based at least in part on the WCD-controlled operation mode.
Aspect 35: A method of wireless communication performed by a forwarding node, comprising: transmitting an indication of a wireless communication device (WCD) controlled operation mode; and communicating with a WCD based at least in part on the WCD-controlled operation mode.
Aspect 36: A method of wireless communication performed at a wireless communication device (WCD), comprising: receiving an indication of a WCD-controlled operation mode associated with a forwarding node; and communicating, via the forwarding node, with an additional WCD based at least in part on the WCD-controlled operation mode.
Aspect 37: A method of wireless communication performed at a forwarding node, comprising: transmitting an indication of a selection of a wireless communication device (WCD) controlled operation mode, wherein the selection is obtained from a control node or determined by the forwarding node; and communicating with a WCD based at least in part on the WCD-controlled operation mode.
Aspect 38: The method of Aspect 37, wherein the WCD-controlled operation mode comprises an operation mode for communications based at least in part on control information received from an additional WCD that is different from the WCD.
Aspect 39: The method of any of Aspects 37-38, wherein the WCD-controlled operation mode comprises an operation mode for communications based at least in part on one or more of: control information identified by the forwarding node, control information received from a network control node that is different from the WCD, or control information received from the WCD.
Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.
Aspect 41: An apparatus for wireless communication at a device, the apparatus comprising one or more memories and one or more processors coupled to the one or more memories, the one or more processors configured to cause the device to perform the method of one or more of Aspects 1-39.
Aspect 42: An apparatus for wireless communication, the apparatus comprising at least one means for performing the method of one or more of Aspects 1-39.
Aspect 43: A non-transitory computer-readable medium storing code for wireless communication, the code comprising instructions executable by one or more processors to perform the method of one or more of Aspects 1-39.
Aspect 44: A non-transitory computer-readable medium storing a set of instructions for wireless communication, the set of instructions comprising one or more instructions that, when executed by one or more processors of a device, cause the device to perform the method of one or more of Aspects 1-39.
Aspect 45: A device for wireless communication, the device comprising a processing system that includes one or more processors and one or more memories coupled with the one or more processors, the processing system configured to cause the device to perform the method of one or more of Aspects 1-39.
Aspect 46: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-39.
Aspect 47: An apparatus for wireless communication at a user equipment (UE), the apparatus comprising one or more memories and one or more processors coupled to the one or more memories, the one or more processors configured to individually or collectively cause the UE to perform the method of one or more of Aspects 1-39.
Aspect 48: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a forwarding node, comprising:
one or more memories; and
one or more processors coupled with the one or more memories and configured to cause the forwarding node to:
transmit an indication of a selection of a wireless communication device (WCD) controlled operation mode, wherein the selection is obtained from a control node or determined by the forwarding node; and
communicate with a WCD based at least in part on the WCD-controlled operation mode.

2. The apparatus of claim 1, wherein the WCD-controlled operation mode comprises an operation mode for communications based at least in part on control information received from an additional WCD that is different from the WCD.

3. The apparatus of claim 1, wherein the WCD-controlled operation mode comprises an operation mode for communications based at least in part on one or more of:
control information identified by the forwarding node,
control information received from a network control node that is different from the WCD, or
control information received from the WCD.

4. The apparatus of claim 1, wherein the selection of the WCD-controlled operation mode is based at least in part on one or more of:
channel conditions of a wireless link from the WCD and the forwarding node,
channel conditions of a wireless link from the forwarding node to an additional WCD that is in communication with the WCD via the forwarding node,
mobility of the forwarding node,
mobility of the WCD,
mobility of the additional WCD, or
a likelihood of success of autonomous identification of control information by the forwarding node.

5. The apparatus of claim 1, wherein the selection of the WCD-controlled operation mode is based at least in part on one or more of:
one or more parameters received from the WCD,
one or more parameters configured for the forwarding node, or
one or more parameters received from the control node that is different from the WCD.

6. The apparatus of claim 5, wherein the one or more parameters are associated with one or more of:
thresholds of metrics associated with candidate WCD-controlled operation modes,
ranges of the metrics associated with candidate WCD-controlled operation modes,
observation windows for obtaining the metrics, or
averaging functions for obtaining the metrics.

7. The apparatus of claim 5, wherein the one or more processors are further configured to cause the forwarding node to:
transmit an indication of the one or more parameters.

8. The apparatus of claim 5, wherein the one or more parameters configured for the forwarding node are preconfigured.

9. The apparatus of claim 1, wherein the selection of the WCD-controlled operation mode is associated with one or more of:
a set of time resources,
a set of frequency resources, or
a set of spatial resources.

10. The apparatus of claim 1, wherein the WCD-controlled operation mode is associated with a reduction or omission of control information received from the WCD.

11. The apparatus of claim 10, wherein the control information is associated with one or more of:
beamforming for a link between the forwarding node and an additional WCD that is in communication with the WCD,
time division duplexing (TDD),
on-off controls,
a power configuration,
a frequency configuration for forwarding, or
beamforming for a link between the forwarding node and the WCD.

12. The apparatus of claim 1, wherein the one or more processors, to cause the forwarding node to transmit the indication of the selection of the WCD-controlled operation mode, are configured to cause the forwarding node to transmit the indication of the selection via one or more of:
a capability report,
uplink control information,
a medium access control (MAC) control element (CE),
radio resource control (RRC) signaling, or
operation, administration, and management (OAM) signaling.

13. The apparatus of claim 1, wherein the one or more processors are further configured to cause the forwarding node to:
receive an acknowledgement of the indication of the selection of the WCD-controlled operation mode,
wherein communicating with the WCD based at least in part on the WCD-controlled operation mode is based at least in part on receiving the acknowledgement.

14. The apparatus of claim 1, wherein the one or more processors, to cause the forwarding node to communicate with the WCD based at least in part on the WCD-controlled operation mode, are configured to cause the forwarding node to:
communicate using a configuration of one or more communication parameters that are selected without an indication of the selection from the WCD.

15. The apparatus of claim 14, wherein the selection of the one or more communication parameters comprises:
selection of the one or more communication parameters from a set of candidate communication parameters indicated to the WCD, or
selection of the one or more communication parameters from a set of candidate communication parameters indicated by the WCD or the control node.

16. The apparatus of claim 1, wherein the WCD-controlled operation mode is a candidate WCD-controlled operation mode of a set of candidate WCD-controlled operation modes.

17. The apparatus of claim 1, wherein the one or more processors are further configured to cause the forwarding node to:
receive an indication of control information associated with a default WCD-controlled operation mode, and
communicate, before or after communicating based at least in part on the WCD-controlled operation mode, with the WCD based at least in part on the default WCD-controlled operation mode.

18. The apparatus of claim 1, wherein the one or more processors are further configured to cause the forwarding node to:
receive a set of information elements of control information based at least in part on the WCD-controlled operation mode.

19. An apparatus for wireless communication at a wireless communication device (WCD), comprising:
one or more memories; and
one or more processors coupled with the one or more memories and configured to cause the WCD to:
receive an indication of a selection of a WCD-controlled operation mode associated with a forwarding node; and
communicate, via the forwarding node, with an additional WCD based at least in part on the WCD-controlled operation mode.

20. The apparatus of claim 19, wherein the WCD-controlled operation mode comprises an operation mode for communications based at least in part on one or more of:
control information received from a network control node that is different from the WCD,
control information received from an additional WCD that is different from the WCD, or
control information received from the WCD.

21. The apparatus of claim 19, wherein the selection of the WCD-controlled operation mode is based at least in part on one or more of:
channel conditions of a wireless link from the WCD and the forwarding node,
channel conditions of a wireless link from the forwarding node to the additional WCD,
mobility of the forwarding node,
mobility of the WCD,
mobility of the additional WCD in communication with the WCD via the forwarding node, or
a likelihood of success of autonomous identification of control information by the forwarding node.

22. The apparatus of claim 19, wherein the selection of the WCD-controlled operation mode is based at least in part on one or more of:
one or more parameters transmitted by the WCD,
one or more parameters configured for the forwarding node, or
one or more parameters received from a control node that is different from the WCD.

23. The apparatus of claim 22, wherein the one or more parameters are associated with one or more of:
thresholds of metrics associated with candidate WCD-controlled operation modes,
ranges of the metrics associated with candidate WCD-controlled operation modes,
observation windows for obtaining the metrics, or
averaging functions for obtaining the metrics.

24. The apparatus of claim 19, wherein the selection of the WCD-controlled operation mode is associated with one or more of:
a set of time resources,
a set of frequency resources, or
a set of spatial resources.

25. The apparatus of claim 19, wherein the one or more processors, to cause the WCD to receive the indication of the selection of the WCD-controlled operation mode, are configured to cause the WCD to receive the indication of the selection via one or more of:
a capability report,
uplink control information,
a medium access control (MAC) control element (CE),
radio resource control (RRC) signaling, or
operation, administration, and management (OAM) signaling.

26. The apparatus of claim 19, wherein the one or more processors are further configured to cause the WCD to:
transmit an acknowledgement of the indication of the selection of the WCD-controlled operation mode,
wherein communicating with the additional WCD based at least in part on the WCD-controlled operation mode is based at least in part on transmitting the acknowledgement.

27. The apparatus of claim 19, wherein the one or more processors, to cause the WCD to communicate with the additional WCD based at least in part on the WCD-controlled operation mode, are configured to cause the WCD to:
communicate based at least in part on the forwarding node using a configuration of one or more communication parameters that are selected without an indication of the selection from the WCD.

28. The apparatus of claim 19, wherein the one or more processors are further configured to cause the WCD to:
transmit an indication of one or more parameters of a default WCD-controlled operation mode, and
communicate, before or after communicating based at least in part on the WCD-controlled operation mode, with the additional WCD based at least in part on the forwarding node using the default WCD-controlled operation mode.

29. A method of wireless communication performed at a forwarding node, comprising:
transmitting an indication of a selection of a wireless communication device (WCD) controlled operation mode, wherein the selection is obtained from a control node or determined by the forwarding node; and
communicating with a WCD based at least in part on the WCD-controlled operation mode.

30. A method of wireless communication performed at a wireless communication device (WCD), comprising:
receiving an indication of a selection of a WCD-controlled operation mode associated with a forwarding node; and
communicating, via the forwarding node, with an additional WCD based at least in part on the WCD-controlled operation mode.
